(19) United States
(12) Patent Application Publication
(10) Pub. No.: US 2025/0293872 A1
(43) Pub. Date: Sep. 18, 2025

(54) METHODS AND SYSTEMS FOR ACCESSING CONTENT

(71) Applicant: Forward Pass, Inc., Beverly Hills, CA (US)

(72) Inventors: Michael Mann, Beverly Hills, CA (US); S. Swaminathan, Royal Oaks, CA (US); Rebecca Mann, Beverly Hills, CA (US)

(21) Appl. No.: 19/060,270

(22) Filed: Feb. 21, 2025

Related U.S. Application Data
(60) Provisional application No. 63/566,673, filed on Mar. 18, 2024.

(51) Int. Cl. H04L 9/08; G06Q 20/06; G06Q 20/36

(52) U.S. Cl. CPC H04L 9/0866; G06Q 20/06; G06Q 20/363

(57) ABSTRACT

Methods, systems, and apparatuses are described that are configured for granting access to one or more content assets, such as an image, a video stream, or an audio stream, based on one or more digital assets in a digital wallet of a user. A user may access an interface based on a digital wallet of the user. The one or more digital assets of the digital wallet of the user may be compared with one or more required digital assets for accessing one or more content assets. Based on at least one of the digital assets of the digital wallet matching at least one of the required digital assets, the user may be granted access to at least one of the content assets.

### CROSS-REFERENCE TO RELATED APPLICATION

This application claims the priority benefit of U.S. Provisional Application No. 63/566,673, filed Mar. 18, 2024, the entirety of which is incorporated herein by reference.

### BACKGROUND

Digital content distribution systems have become increasingly complex, incorporating various access control mechanisms to protect valuable media assets. Traditional content delivery platforms often rely on simple username and password authentication, which can be vulnerable to security breaches and unauthorized sharing. As the value of digital content continues to rise, content creators and distributors face challenges in ensuring that only authorized users can access their assets.

Conventional digital rights management (DRM) systems typically use encryption and licensing schemes to control access to content. However, these systems can be cumbersome for users and may not provide sufficiently granular control over content access. Additionally, they often struggle to adapt to emerging technologies and changing user preferences, potentially limiting the ways in which content can be monetized and distributed.

The limitations of existing content access control systems have led to difficulties in implementing flexible and secure distribution models. For instance, content providers may wish to offer tiered access or temporary permissions based on ownership of specific digital assets, but conventional systems lack the infrastructure to efficiently manage such complex access rules. This inflexibility can result in missed opportunities for content creators to engage with their audience and maximize the value of their digital assets.

Furthermore, the rise of blockchain technology and digital assets such as non-fungible tokens (NFTs) has introduced new possibilities for content access control and ownership verification. However, integrating these technologies with existing content distribution platforms presents technical challenges that conventional systems are not equipped to address. The inability to leverage these emerging technologies hinders innovation in content distribution.

Advancements in computing devices and networking technology have led to a variety of innovations in providing digital content to, and sharing digital content among, user accounts. However, conventional digital content systems often risk overexposure of sensitive information. For example, conventional login systems operate by a user providing a username and a password in exchange for access to a website. However, the personal data of the user is stored and managed in a centralized database. The website visitors do not own the data they upload and cannot actively control the flow of their data. In addition, the entities that own the content and the personal data of the websites' visitors are free to sell the visitors' personal data as they wish. In recent years, significant advancements have been made in hardware and software platforms for blockchain technology that include managing distributed ledger databases across networks of computing devices. These blockchain systems can manage a consensus/immutable ledge via a network of entities distributed throughout the world and without a central entity that can be corrupted or otherwise manipulated to undermine the security and performance of the digital ledger. Moreover, the anonymous nature of blockchains make blockchains useful for preventing the sharing of an individual's personal/sensitive information. However, conventional digital content systems that utilize blockchain technology suffer from a number of disadvantages. For example, these systems do not provide a method for generating and managing digital assets as part of a blockchain. In addition, these systems require a user account to own or otherwise be associated with a specific digital asset to access digital content. Moreover, these systems require the visitors' user devices to locate specific digital assets from their own respective digital asset systems and to further provide the digital asset to a digital content system to gain access to the content assets.

### SUMMARY

It is to be understood that both the following general description and the following detailed description are exemplary and explanatory only and are not restrictive.

Methods, systems, and apparatuses for improved access of content assets using a blockchain network are described. An interface, such as a webpage or an application of a user device, and one or more digital assets, such as non-fungible tokens (NFTs), may be generated by a computing device, such as a server. A smart contract may be generated that requires one or more digital assets to be owned by a user in order to access one or more content assets via the interface. A user may access the interface via a digital wallet associated with the user. The user's digital wallet may include one or more digital assets that are owned by the user. The one or more digital assets of the user's digital wallet may be compared with the one or more required digital assets to determine if the user has any access rights to the or more content assets. If the user owns at least one of the one or more required digital assets (e.g., at least one digital asset of the user's digital wallet matches at least one required digital asset), the user may access the content asset. If the user does not license at least one of the one or more required digital assets, the user may be provided an option to purchase at least one of the one or more required digital assets in order to gain access to one or more of the content assets.

In an embodiment are methods comprising generating, by a computing device, an interface and one or more first digital assets for facilitating access to one or more content assets via the interface, receiving a request to access the interface via a digital wallet, wherein the digital wallet is associated with a wallet address, determining one or more second digital assets associated the digital wallet, determining, based on the one or more second digital assets and the one or more first digital assets, access rights associated with each content asset of the one or more content assets, generating, based on the access rights associated with each content asset, one or more identifiers associated with the wallet address for facilitating access to at least one content asset of the one or more content assets, and providing, based on the one or more identifiers, access to the at least one content asset.

In an embodiment are methods comprising generating, by a computing device, an interface and one or more first digital assets for facilitating access to one or more content assets via the interface, receiving a request to access the interface via a digital wallet, wherein the digital wallet is associated with a wallet address, determining one or more second digital assets associated the digital wallet, determining, based on the one or more second digital assets and the one or more first digital assets, access rights associated with each content asset of the one or more content assets, providing, based on the access rights associated with each content asset, access to at least one content asset of the one or more content assets, and associating, based on providing access to the at least one content asset, one or more identifiers with one or more of the interface or the at least one content asset, wherein the one or more identifiers are associated with the wallet address.

In an embodiment are methods comprising receiving, by a computing device, based on a digital wallet, a request to output a content asset via an interface, wherein the content asset comprises a plurality of frames, determining one or more digital assets associated with the digital wallet, providing, based on a digital asset of the one or more digital assets, access to the content asset, wherein the content asset is output via the interface based on being provided access to the content asset, generating, based on providing access to the content asset, one or more identifiers associated with the digital wallet, and embedding the one or more identifiers in each frame of the content asset as the content asset is being output via the interface.

In an embodiment are methods comprising generating, by a computing device, an interface and one or more first digital assets for facilitating access to one or more content assets via the interface, receiving a request to access the one or more content assets via biometric information, wherein the biometric information is associated with a biometric user profile, determining one or more second digital assets associated with the biometric user profile, determining, based on the one or more second digital assets and the one or more first digital assets, access rights associated with each content asset of the one or more content assets, and providing, based on the access rights associated with each content asset, access to at least one content asset.

In an embodiment are methods comprising generating, by a computing device, an interface and one or more biometric user profiles for facilitating access to one or more content assets via the interface, receiving a request to access the one or more content assets via biometric information, determining, based on the biometric information, a biometric user profile of the one or more biometric user profiles, determining, based on the biometric user profile, access rights associated with each content asset of the one or more content assets, and providing, based on the access rights associated with each content asset, access to at least one content asset.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1A shows an example system for providing access to content assets based on a blockchain;

FIG. 1B shows an example biometric authentication and NFT access control system;

FIG. 2 shows an example blockchain system;

FIG. 3 shows an example blockchain network environment;

FIG. 4 shows example user wallets;

FIG. 5 shows an example blockchain network environment

FIG. 6 shows a flowchart of an example method;

FIG. 7 shows a flowchart of an example method;

FIG. 8 shows a flowchart of an example method;

FIG. 9 shows a flowchart of an example method;

FIG. 10 shows a flowchart of an example method;

FIG. 11 shows a flowchart of an example method; and

FIG. 12 shows a flowchart of an example method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes-from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

“Hashes” (also referred to herein as “hash functions,” “cryptographic hash functions,” and the like) include functions that map an initial input data set to an output data set. The output from a hash function may be referred to herein as a “hash identifier,” “hash value,” “hash data set,” or simply, a “hash”). Generally, the output values from a given hash function have the same fixed length. Generally, if the same hash function is used on the same input data it will result in the same output data value. With some hash functions (including those used in the context of blockchain techniques and/or the subject matter of this application) the input value is computationally difficult to determine when only the output value is known. In certain examples, the input value for the hash function is supplemented with some additional random data. For example, an input value of “blockchain” for a hash function may include additional random data such as three random characters. Accordingly, the data value that is hashed may be “blockchaina7h” instead of simply “blockchain.” The additional random data is sometimes called a “nonce.”

As used herein, the terms “digital asset,” “token asset,” or “token” may indicate a digital currency or a cryptocurrency, such as Simba coin, Bitcoin, Litecoin, TorCoin, Ethereum, etc.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user,” or “individual,” may indicate a person who uses an electronic device or digital wallet.

The present disclosure relates to systems and methods for controlling access to digital content using biometric information and digital assets. This approach may provide enhanced security and personalization for content delivery platforms while leveraging blockchain technologies. In some cases, the systems and methods described herein may allow content providers to gate access to digital content based on ownership of specific digital assets, such as non-fungible tokens (NFTs) or cryptocurrencies. The systems may authenticate users through biometric data rather than traditional login credentials. This biometric authentication may be linked to digital wallets or user profiles containing the requisite digital assets for content access. The disclosed techniques may offer several advantages over conventional content access control systems. For example, the use of biometric data may reduce the risk of credential theft or unauthorized account access. Additionally, tying content access to ownership of blockchain-based digital assets may enable new models for content monetization and engagement. In some implementations, the systems may embed identifying information into the delivered content, allowing for tracking of potential unauthorized sharing or distribution. This may help content owners protect their intellectual property rights while still enabling flexible access models.

The approaches described herein represent advancements in content delivery technologies by combining biometric authentication, blockchain-based digital asset verification, and dynamic content protection techniques. These innovations address limitations of existing systems related to security, personalization, and digital rights management. The system includes several interconnected components that work together to provide content access functionality. By integrating these various components and processes, the content access system offer improvements in security, efficiency, and user experience compared to conventional content delivery platforms. The combination of biometric authentication, blockchain-based asset verification, and advanced content protection techniques may address limitations in existing systems related to unauthorized access, content piracy, and inflexible monetization models. These advancements contribute to a more secure, personalized, and engaging environment for digital content consumption.

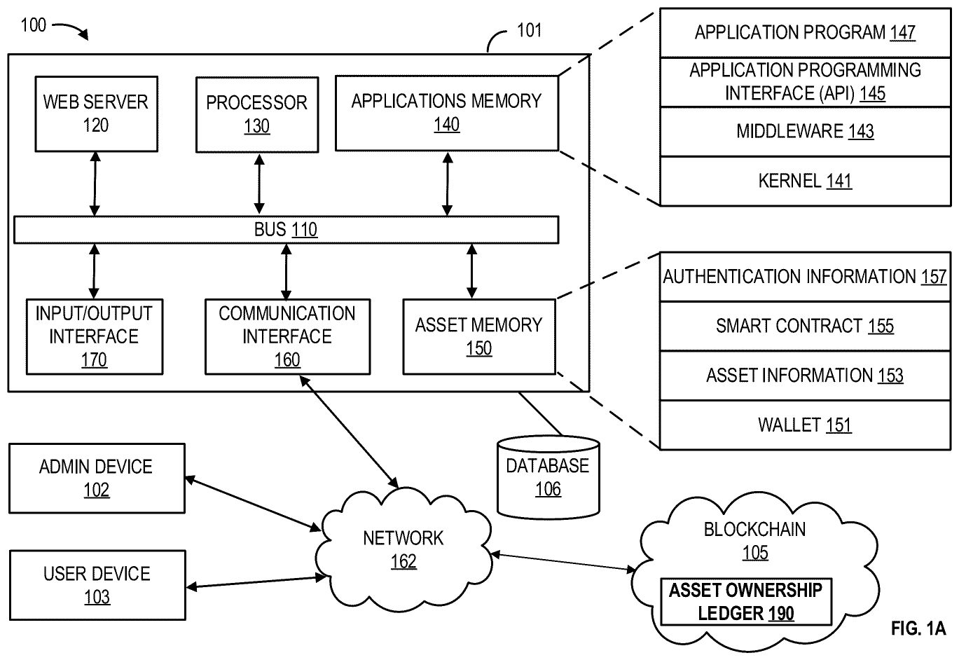

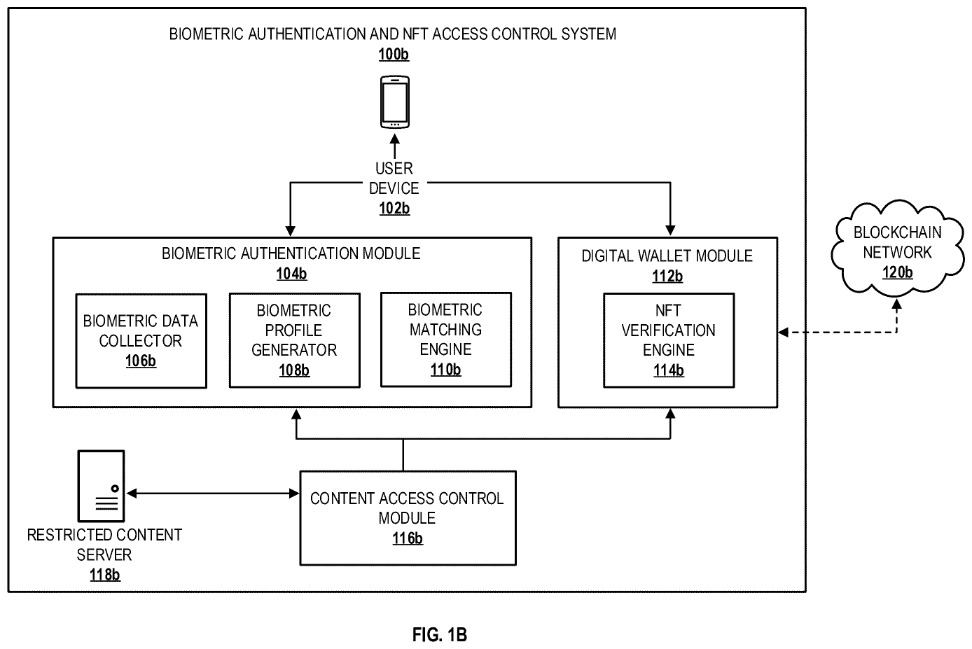

FIG. 1A shows an example digital content access system 100 including a server computing device 101 for implementing the digital content access system using one or more blockchains for determining access to content assets of the digital content access system. The system 100 may include a blockchain system 105 for storing one or more ledgers related to one or more asset types (e.g., a digital asset), a server computing system 101 for performing operations utilizing the one or more ledgers, and one or more user devices 102, 103 for accessing services provided by the server computing system 101. The blockchain system 105, server computing device 101, and the user devices 102, 103 may be interconnected by a network 162. The network environment 100 may also include one or more databases 106 providing access to various data and/or processing by third party systems. The databases 106 may be connected to the server computing system 101 directly or indirectly through network 162.

The server computing device 101 may include a bus 110, a webserver 120, a processor 130, an application memory 140, an asset memory 150, a communication interface 160, and an input/output interface 170. In an example, the server computing device 101 may omit at least one of the aforementioned constitutional elements or may additionally include other constitutional elements. In an example, the server computing device 101 may include a plurality of servers.

The bus 110 may include a circuit for connecting the bus 110, the webserver 120, the processor 130, the application memory 140, the asset memory 150, the communication interface 160, and the input/output interface 170 to each other and for delivering communication (e.g., a control message and/or data) between the bus 110, the webserver 120, the processor 130, the application memory 140, the asset memory 150, the communication interface 160, and the input/output interface 170.

Web server 120 may include one or more web servers and/or other servers, such as, but not limited to, application servers, load balancing servers, etc., and operates to receive inputs from operators including administrators and users of the server computing device 101. Web server 120, in response to inputs received from an operator or in response to internally-generated signals, may perform or cause the server computing device 101 to perform operations for maintaining records of asset ownership in an immutable manner using a blockchain, and/or for providing services utilizing immutable records of asset ownership in a blockchain.

The processor 130 may include one or more of a Central Processing Unit (CPU), an Application Processor (AP), and a Communication Processor (CP). The processor 130 may control, for example, at least one of the bus 110, the webserver 120, the processor 130, the application memory 140, the asset memory 150, the communication interface 160, and the input/output interface 170 of the server computing device 101 and/or may execute an arithmetic operation or data processing for communication. The processing (or controlling) operation of the processor 130 according to various embodiments is described in detail with reference to the following drawings.

Processor-executable instructions executed by the processor may be stored and/or maintained by the applications memory 140. The applications memory 140 may include a volatile and/or non-volatile memory. The applications memory 140 may comprise random-access memory (RAM), flash memory, solid state or inertial disks, or any combination thereof. The applications memory 140 may store, for example, a command or data related to at least one of the bus 110, the webserver 120, the processor 130, the asset memory 150, the communication interface 160, and the input/output interface 170 of the server computing device 101. As an example, the applications memory 140 may store a software and/or a program. The program may include, for example, a kernel 141, a middleware 143, an Application Programming Interface (API) 145, and/or an application program (or an “application”) 147, or the like, configured for controlling one or more functions of the server computing device 101 and/or an external device. At least one part of the kernel 141, middleware 143, or API 145 may be referred to as an Operating System (OS). The applications memory 140 may include a computer-readable recording medium having a program recorded therein to perform the method according to various embodiment by the processor 130.

The kernel 141 may control or manage, for example, system resources (e.g., the bus 110, the processor 130, the applications memory 140, etc.) used to execute an operation or function implemented in other programs (e.g., the middleware 143, the API 145, or the application program 147). Further, the kernel 141 may provide an interface capable of controlling or managing the system resources by accessing individual constitutional elements of the server computing device 101 in the middleware 143, the API 145, or the application program 147.

The middleware 143 may perform, for example, a mediation role so that the API 145 or the application program 147 can communicate with the kernel 141 to exchange data.

Further, the middleware 143 may handle one or more task requests received from the application program 147 according to a priority. For example, the middleware 143 may assign a priority of using the system resources (e.g., the bus 110, the processor 130, or the applications memory 140) of the server computing system 101 to at least one of the application programs 147. For example, the middleware 143 may process the one or more task requests according to the priority assigned to the at least one of the application programs, and thus may perform scheduling or load balancing on the one or more task requests.

The API 145 may include at least one interface or function (e.g., instruction), for example, for file control, window control, video processing, or character control, as an interface capable of controlling a function provided by the application program 147 in the kernel 141 or the middleware 143.

The application program 147 may include logic (e.g., hardware, software, firmware, etc.) that may be implemented to provide an interface to a user for accessing one or more content assets. The interface may comprise a webpage the user may access via the network 162 (e.g., Internet) or a user application installed on a user device (e.g., user device 103) of the user. In an example, the interface may be formatted for virtual reality (VR) or augmented reality (AR). The interface may grant access to one or more content assets (e.g., media streams, video streams, audio streams, image content, etc.) based on the subscription requirements for the corresponding content asset. For example, the application program 147 may implement one or more subscription requirements associated with a smart contract (e.g., via the smart contract memory 155 of the asset memory 150) for accessing the one or more content assets. A user accessing the interface may be required to enter credentials associated with a digital wallet owned by the user, wherein the digital wallet may include one or more digital assets that are owned by the user. The interface may authenticate a user as the owner of the digital wallet, wherein the digital wallet may be used to validate the user as the owner of the digital assets of the digital wallet. As an example, each digital asset of the digital wallet may comprise identifying information of an owner (e.g., the user) of the one or more digital assets included in the digital wallet. The smart contract may indicate that each content asset may require a user accessing the corresponding content asset to own/include a required digital asset (e.g., non-fungible token (NFT)) in the user's digital wallet in order to access the corresponding content asset. The user may be granted access to the corresponding content asset if the user has the required digital asset in the user's digital wallet. If the user does not have the corresponding digital asset in the user's digital wallet, the user may be provided an option to purchase the required digital asset to access the corresponding digital asset.

In an example, the user may be provided/granted access to the interface based on one or more of a QR code of the interface, a wallet extension associated with the digital wallet, a hard wallet associated with the digital wallet, physical biometric data associated with the digital wallet, or behavioral biometric data associated with the digital wallet. The physical biometric data may comprise one or more of a fingerprint, palm veins, facial features, DNA, a palm print, hand geometrics, iris recognition, voice, or gait. The behavioral biometric data comprises one or more of continuous authentication, keystrokes associated with a user device, location data, or lip movements. As an example, biometrics may be used to identify an individual based on the unique features of a modality (e.g., voice, face, etc.) being used, wherein the biometrics may be converted to a mathematical representation. For example, in voice recognition, a biometric modality identifies and authenticates an individual based on unique features of the individual's voice. To convert a voice sample into a mathematical representation, a feature extraction technique may be used to analyze the characteristics and dynamics of the acoustic wave the person produces. A template may then be created, which may include a set of floating point numbers that represents the individual's voice. The template may be used for matching the individual's voice for authentication purposes. As an example, an algorithm or compression method may be generated to reduce the mathematical representation to the fewest floating point numbers possible to extract features of identification to identify the individual. A unique biometric user profile for identifying individuals requesting access to the content assets may be generated and stored (e.g., on the server computing device 101, on the database 106, or on the user device 103) for each user based on the generated floating point numbers. The floating point numbers may be displayed (e.g., low opacity) at a predetermined time interval to identify the user. In an example, time codes associated with each floating point number may be used to determine where in the sequence each floating point number will be displayed.

In an example, a user accessing the interface may be required to provide biometric information associated with the user in order to access the content assets. For example, the user's biometric information may be collected when the user purchases one or more of the digital assets used for facilitating access to the content assets. A biometric user profile for the user may be generated based on the user's biometric information. The subscriptions to the content assets may be associated with the user's biometric user profile. As an example, instead of using a wallet address of a user's digital wallet for accessing the blockchain and confirming the ownership of the digital assets, the user's biometric information may be used to access the blockchain and confirm the digital assets associated with the user's biometric user profile (e.g., showing the user owns the digital assets). The user may be granted access to the content assets based on whether the user has the required digital assets associated with the user's biometric user profile.

In an example, the application program 147 may implement one or more subscription requirements for accessing the content that may simply include that the user's biometric user profile be associated with the subscription to one or more of the content assets instead of digital assets being associated with the user's biometric user profile. For example, the user's biometric information may be collected when the user purchases access to the content assets. A biometric user profile for the user may be generated based on the user's biometric information. The subscriptions to the content assets may be associated with the user's biometric user profile. The user may be granted access to the content assets based on whether the user's biometric user profile is associated with subscriptions to the content assets.

In an example, the one or more content assets may be encrypted. Based on granting access to at least one of the content assets, a decryption key for the corresponding content asset may be associated with the digital wallet. For example, the digital wallet may be associated with a wallet address. The decryption key may be associated with the wallet address of the digital wallet. For example, the decryption key may be stored at a server associated with the interface or a third party provider. The user's user device (e.g., user device 103) may access the decryption key based on the association with the wallet address in order to stream the corresponding content asset. In an example, the decryption key may be associated with a user's biometric user profile instead of, or in addition to, the user's digital wallet. In an example, the decryption key may be separated (e.g., broken) into a plurality of portions and stored across a blockchain network.

As an example, based on granting access to at least one of the content assets, one or more identifiers may be generated. The one or more identifiers may comprise one or more of a unique user identifier associated with an owner of the digital wallet or a user of the biometric user profile, a digital asset (e.g., NFT), a wallet address of the digital wallet, a forensic watermark, a visible watermark, metadata, or software codes associated with the digital wallet. In an example, the one or more identifiers may be associated with the wallet asset for facilitating access to the at least one content asset. The user associated with the digital wallet may access the at least one content asset based on the one or more identifiers. In an example, the one or more identifiers may be embedded in one or more of the interface (e.g., display of the interface) or the at least one content asset (e.g., digital rights management (DRM) protection). The interface and/or the at least one content asset embedded with the one or more identifiers may be unique for each user that accesses the content asset. For example, DRM may be used to prevent the unauthorized access to the content asset, such as preventing the sharing of a URL of the content asset to an unauthorized individual and preventing an unauthorized individual from recording the content asset. In an example, the one or more identifiers may be stored, and/or associated with the wallet address, and subsequently embedded (e.g., imperceptibly or visibly) into the content asset each time the content asset is output via the interface. For example, an identifier may comprise an indication or image of the digital asset (e.g., NFT), an indication or image of the wallet address, or an indication or image of a combination of both the digital asset and the wallet address. The content asset may comprise a plurality of frames. The indication/image may be embedded, imperceptibly or visibly, into each frame of the content asset as the content asset is being output via the interface. The indication/image may be tracked each time the digital asset is output. For example, if a user attempts to share the content asset or the content asset is leaked without authorization, the identifier may be tracked as the content asset is output. Thus, the unauthorized access/sharing of the content asset may be traced back to the digital wallet (e.g., via the embedded NFT or the embedded wallet address) that shared/leaked the content asset without authorization.

The server computing device 101 may further include asset memory 150. Asset memory 150 may include wallet memory 151 and, optionally, one or more other storage memories including asset information 153, asset ownership information 155, and authentication information 157. As an example, the asset memory 150 may be included within the same memory unit/device as the applications memory 140.

Similar to the applications memory 140, the asset memory 150 may include a volatile and/or non-volatile memory. In an example, the asset memory 150 may include data structures or other logical structures used to store associated data on one or more common or dedicate electronic data storage (e.g., RAM, FLASH memory, or a hard-drive). In an example, dedicated hardware devices, such as a hardware security module (HSM), may be used to store information associated with the asset memory 150. In an example, the asset memory 150 may be stored on a dedicated storage hardware externally provided and in communication with the server computing device 101, including the database 106.

Wallet memory 151 may store a “digital wallet” for each of one or more individuals who have at least temporary ownership of a digital asset (e.g., a cryptocurrency or a NFT) stored on the blockchain, in order for that individual to access the server computing device 101 and the blockchain system 105. A digital wallet may enable the “owner” of that digital wallet to interact with the blockchain system 105. In an example, each digital asset may be configured to indicate an ownership of the digital asset (e.g., via identifying information). Each digital wallet may comprise a wallet address, wherein the wallet address may comprise a unique identifier configured for sending and receiving a digital asset. The “owner” of a digital wallet may be an administrative user for the server computing device 101, an administrative user for an entity, or an end-user of an application utilizing the blockchain system. For example, wallet memory 151 may include a digital wallet for an individual of a user device (e.g., user device 103) by which that individual can record information (e.g., by submitting a transaction) to the blockchain, for example, to a ledger of records of asset ownership 190, cause processing using information accessed from the blockchain, and enable other participants in the system to send transactions to that individual. In an example, one or more of the user devices (e.g., user device 103) may store at least a part of the digital wallet for that individual.

Asset information memory 153 may store information regarding assets related to operations performed by the server computing device 101 while utilizing the blockchain system 105. For example, asset information memory 153 may store the name of each digital asset (e.g., shares of particular type), issuer information, total issued number of the digital asset, etc., for which ownership is recorded in the blockchain. In an example, each digital asset of a digital wallet may comprise identifying information of an owner (e.g., the user) of the one or more digital assets included in the digital wallet. For example, the asset information memory 153 may further include asset ownership information. For example, the asset ownership information may include a copy of asset ownership information recorded in the blockchain.

Smart contract information 155 may comprise data indicative of a digital asset requirement (e.g., smart contract) for accessing a corresponding content asset. For example, an individual may be required to own a required digital asset in order to gain access to a corresponding content asset. As an example, the smart contract may specify that an individual content asset (e.g., movie, image, video, audio, etc.) or a collection of content assets (e.g., all access pass, behind the scenes access, series, group of images, group of audio content, etc.) may be accessed based on specified digital assets. For example, an individual may access either the individual content asset or the collection of content assets based on the digital assets owned by the individual (e.g., in the individual's digital wallet or associated with the individual's biometric user profile). The smart contract information 155 may further specify that if an individual does not have the required digital asset for accessing a desired content asset, the individual may be provided with an option to purchase the required digital asset. Once the individual purchases the required digital asset and it is added to the individual's digital wallet, or it is associated with the individual's biometric user profile, the individual may be granted access to the corresponding content asset. In an example, the smart contract information 155 may provide the data indicative of the smart contract that may be implemented within the blockchain 105.

The smart contract may further provide the functions for minting (e.g., generating) digital assets (e.g., NFTs), determining/validating ownership of those digital assets, and transferring ownership of those digital assets from a current valid owner to a new owner. When the smart contract is used to mint digital assets, the minting and ownership data for that digital asset may be recorded on the blockchain 105. In one example, the digital asset data recorded on the blockchain 105 may include a unique digital asset identifier. In another example, the digital asset data recorded on the blockchain 105 may include one or more media files or uniform resource identifier (URI) link(s) to the one or more media files of the digital asset. The media files may comprise one or more of an image file, a video file, an audio file, combinations thereof, etc. The digital assets minted and managed by the smart contract may be considered part of a collection of digital assets in that they are all governed by the same smart contract. As an example, each content asset or each collection of content assets may be associated with a single smart contract that governs the required digital asset(s) for accessing the corresponding content asset or corresponding collection of content assets.

Authentication information memory 157 may store information for authenticating the users of the system. The users of the system may be owners of digital assets recorded in memories 153 and/or 155, proxies for digital asset owners, etc.

The communication interface 160 may establish, for example, communication between the server computing device 101 and the external devices (e.g., a user devices 102-104). For example, the communication interface 160 may communicate with the external device (e.g., a user devices 102-104) by being connected to a network 162 through wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. The wired communication may include, for example, at least one of Universal Serial Bus (USB), High Definition Multimedia Interface (HDMI), Recommended Standard-232 (RS-232), power-line communication, Plain Old Telephone Service (POTS), and the like. The network 162 may include, for example, at least one of a telecommunications network, a computer network (e.g., LAN or WAN), the internet, and a telephone network.

The input/output interface 170 may comprise an interface for delivering an instruction or data input from a user or a different external device(s) to the different constitutional elements of the server computing device 101. Further, the input/output interface 170 may output an instruction or data received from the different constitutional element(s) of the server computing device 101 to the different external device. In an example, the input/output interface 170 may be a web-based interface which enables an administrator or other operator to access information stored on the blockchain and/or to store information on the blockchain. The input/output interface 170 may include a client-based part which executes on the access device (e.g., admin device 102, user device 103) being used by an administrator or other operator, and a server part which may be performed by the web server 134. The input/output interface 170 may include a web-based or app-based graphical user interface (GUI) for creating and managing accounts, administering/adjusting voting rights, etc.

The server computing device 101 may include a group of one or more servers. For example, all or some of the operations executed by the server computing device 101 may be executed in a different one or a plurality of electronic devices (e.g., the admin device 102 or the user device 103). As an example, if the server computing device 101 needs to perform a certain function or service either automatically or based on a request, the server computing device 101 may request at least some parts of functions related thereto alternatively or additionally to a different electronic device (e.g., the admin device 102 or the user device 103) instead of executing the function or the service autonomously. The different electronic devices (e.g., the admin device 102 or the user device 103) may execute the requested function or additional function, and may deliver a result thereof to the server computing device 101. The server computing device 101 may provide the requested function or service either directly or by additionally processing the received result. For this, for example, a cloud computing, distributed computing, or client-server computing technique may be used.

One or more user devices (e.g., admin device 102, user device 103, client devices etc.) may be used to access the services of the server computing device 101. The one or more user devices (e.g., admin device 102, user device 103, client devices, etc.) may include networked computing devices such as a smart phone, tablet, laptop computer, desktop computer, and the like.

The blockchain system 105 may include one or more processors for processing commands and one or more memories for storing information (e.g., the content asset, content asset information, the digital asset, digital asset information, etc.) in one or more blockchain data structures. The blockchain system 105 may be publically assessable (e.g., a distributed decentralized computing system) or may be privately run by a third party entity or the same entity that is running the server computing device 101. The blockchain system 105 maintains one or more blockchains, or distributed ledgers, of continuously growing lists of data blocks, where each data block refers to previous blocks on its lists. The requirement for each block to refer to all previous blocks in the blockchain yields a chain of blocks that is hardened against tampering and revision, such that the information stored the blockchain is immutable. That is, the work required to successfully tamper with or change data in even one block on the blockchain while still maintaining the validity of the blockchain would impose a cost in computing power and time so prohibitively high, that it is not practically possible for even an administrator of the blockchain system 105 to successfully tamper with or change transaction data already in the blockchain.

Transactions may represent the content to be stored in the blockchain. Blocks of transactions may record and confirm when and in what sequence transactions enter and are logged in the blockchain. The blocks may be created from transactions by one or more administrator nodes or, for example, nodes known as “miners” in the blockchain system which use specialized software and/or hardware designed specifically to create blocks. Once a new block is generated that includes a submitted transaction, that transaction becomes a part of the blockchain. The blockchain is then distributed to the various computing nodes that make up the blockchain system. As an example, blockchain implementations that may be used (e.g., Bitcoin, Chain, Etherium, etc.) can natively encode asset information in the transactions. For example, a specified protocol may be used to associate metadata with the asset information natively encoded in the transaction.

Server computing device 101 may include, or may connect over a network to, the database 106. The database 106 may include one database or multiple databases at one or more locations, and may store account information, audit information, mappings between blockchain transactions and a means of encoding metadata defining aspects of assets to be recorded in the blockchain and other data. In an example, the database 106 may include one or more external databases or data services. For example, the database 106 may include a data service provided by an entity different from the entity controlling the server computing system 101, such as, but not limited to, external data services providing asset information, asset ownership information (e.g., share ownership information), user authentication information, etc. In an example, the server computing device 101 may generate one or more biometric user profiles based on receiving biometric information from one or more individuals. The server computing device 101 may store the one or more biometric user profiles in the database 106.

FIG. 1B illustrates a block diagram of a biometric authentication and NFT access control system 100b. The system 100b may include a user device 102b that interfaces with multiple modules for authentication and content access control. The user device 102b may take various forms to facilitate biometric authentication and NFT-based access control. In some implementations, the user device may be a smartphone, such as an iPhone or Android device, equipped with built-in biometric sensors like fingerprint scanners or facial recognition cameras. Tablets, such as iPads or Samsung Galaxy tablets, may also serve as user devices, offering larger screens for content consumption while still providing biometric authentication capabilities. In other cases, the user device may be a laptop computer with integrated biometric features, such as fingerprint readers or webcams for facial recognition. Desktop computers connected to external biometric peripherals, such as USB fingerprint scanners or specialized iris recognition cameras, may also function as user devices within the system. Wearable devices, including smartwatches or fitness trackers with heart rate sensors, may act as user devices by providing continuous biometric data for authentication. Virtual or augmented reality headsets with eye-tracking capabilities may serve as user devices in immersive content scenarios, using retinal patterns for biometric verification. In some implementations, the user device may be a smart TV or streaming device equipped with voice recognition technology, allowing for user authentication through vocal biometrics. Game consoles with camera attachments or controllers featuring fingerprint sensors may also function as user devices within the biometric authentication and NFT access control system.

The system 100b may comprise a biometric authentication module 104b that includes three components: a biometric data collector 106b, a biometric profile generator 108b, and a biometric matching engine 110b. These components may work together to process biometric information from users.

The biometric authentication module 104b may serve as a core component of the biometric authentication and NFT access control system 100b. This module may be responsible for processing and analyzing biometric data to verify user identities. The module may comprise three main components that work in concert to achieve accurate and efficient biometric authentication.

The biometric data collector 106b may be designed to capture various types of biometric information from users. This component may interface with different sensors and input devices on the user device 102b to gather biometric samples. In some implementations, the biometric data collector 106b may support multiple biometric modalities, such as fingerprints, facial features, voice patterns, and iris scans. The collector may employ advanced signal processing techniques to enhance the quality of captured biometric data, improving the overall accuracy of the authentication process.

The biometric profile generator 108b may take the raw biometric data from the collector and transform it into standardized biometric templates or profiles. This component may utilize sophisticated feature extraction algorithms tailored to each biometric modality. For example, it may apply minutiae extraction for fingerprints, facial landmark detection for facial recognition, or mel-frequency cepstral coefficient (MFCC) analysis for voice recognition. The generated profiles may be optimized for efficient storage and comparison, reducing computational overhead in subsequent matching operations. The biometric user profiles may be implemented as a structured data object that encapsulates various biometric features and metadata associated with a user. In some implementations, the profile may be stored as a JSON (JavaScript Object Notation) document, which provides a flexible and widely supported format for representing complex data structures. The biometric user profiles may comprise one or more of the following components: 1. user identifier: a unique alphanumeric string that serves as a primary key for the profile within the system's database; 2. biometric feature vectors: numerical representations of the user's biometric characteristics, such as: fingerprint minutiae points, facial landmark coordinates, and/or voice frequency patterns; template hashes: cryptographic hashes of the biometric feature vectors, which may be used for quick comparisons without exposing raw biometric data; modality information: metadata indicating which biometric modalities (e.g., fingerprint, face, voice) are included in the profile; quality scores: numerical values representing the quality of each biometric sample, which may be used to weigh the importance of different modalities during matching; timestamp information: creation and last update times of the profile, which may be used for version control and auditing purposes; device information: details about the devices used to capture the biometric data, which may be useful for security analysis and troubleshooting; and/or encryption metadata: information about the encryption methods used to secure the biometric data, including public keys or key identifiers.

The biometric matching engine 110b may be responsible for comparing the newly generated biometric profiles against stored templates to determine user identity. This component may implement a variety of matching algorithms, including both traditional statistical methods and advanced machine learning techniques. In some cases, the matching engine may employ a multi-stage matching process, using fast pre-screening methods followed by more precise comparisons. The engine may also incorporate adaptive thresholding and score normalization techniques to handle variations in biometric data quality and environmental conditions.

The biometric matching engine 110b may incorporate advanced algorithms and techniques to enhance the accuracy and efficiency of biometric comparisons. In some implementations, the engine may utilize deep learning models, such as convolutional neural networks (CNNs) or siamese networks, to extract high-level features from biometric data and perform similarity comparisons. These models may be trained on large datasets of biometric samples to learn robust representations that are invariant to common variations in biometric data collection.

The biometric matching engine 110b may implement a fusion approach that combines results from multiple biometric modalities. This multi-modal fusion may occur at different levels, including feature-level fusion, score-level fusion, or decision-level fusion. In some cases, the engine may employ adaptive fusion strategies that dynamically adjust the weights assigned to different modalities based on factors such as the quality of input samples or the historical performance of each modality for a given user.

To improve computational efficiency, the biometric matching engine 110b may utilize indexing techniques such as locality-sensitive hashing (LSH) or approximate nearest neighbor (ANN) search algorithms. These methods may enable rapid retrieval of potential matches from large biometric databases, reducing the number of full comparisons required and decreasing overall matching time.

The biometric matching engine 110b may incorporate liveness detection algorithms to prevent spoofing attacks. These algorithms may analyze additional features of the biometric data, such as skin texture in facial images or micro-movements in video samples, to determine whether the input comes from a live person rather than a static image or replica.

In some implementations, the biometric matching engine 110b may utilize homomorphic encryption techniques to perform comparisons on encrypted biometric templates. This approach may allow for biometric matching without decrypting the stored templates, enhancing privacy and security in multi-party or cloud-based authentication scenarios.

The biometric matching engine 110b may implement adaptive thresholding techniques that adjust match acceptance criteria based on various contextual factors. These factors may include the security level of the requested access, the quality of input samples, or the user's historical authentication patterns. This adaptive approach may help balance security and usability across different usage scenarios.

To handle temporal variations in biometric data, the biometric matching engine 110b may incorporate time-warping algorithms such as Dynamic Time Warping (DTW) for comparing time-series biometric data like voice patterns or gait sequences. These algorithms may allow for more flexible matching of biometric patterns that may vary in speed or duration.

The biometric matching engine 110b may also implement continuous authentication techniques, where biometric data is repeatedly collected and analyzed throughout a user session. This approach may involve the use of less intrusive biometric modalities, such as keystroke dynamics or behavioral patterns, to maintain a confidence score of the user's identity over time.

In some cases, the biometric matching engine 110b may utilize blockchain technology to create an immutable audit trail of biometric matching operations. This may enhance the system's transparency and accountability, providing a verifiable record of authentication decisions for high-security applications.

The biometric matching engine 110b may incorporate privacy-preserving techniques such as cancelable biometrics or biometric cryptosystems. These methods may allow for the creation of revocable biometric templates, mitigating risks associated with compromised biometric data.

The biometric authentication module 104b may interact with other system components to provide a seamless authentication experience. It may receive input from the user device 102b and communicate authentication results to the content access control module 116b. In some implementations, the module may also interface with the digital wallet module 112b to associate biometric profiles with specific digital assets or NFTs.

To enhance security and privacy, the biometric authentication module 104b may incorporate various protection measures. These may include encryption of biometric data in transit and at rest, secure template storage techniques, and methods to prevent replay attacks or spoofing attempts. The module may also implement privacy-preserving protocols to ensure that biometric data is used solely for authentication purposes and cannot be repurposed without user consent.

In some aspects, the biometric authentication module 104b may support continuous or adaptive authentication. This approach may involve periodically re-verifying the user's identity throughout a session, using less intrusive biometric modalities such as keystroke dynamics or gait analysis. Such continuous authentication may provide an additional layer of security for high-value or sensitive content access scenarios.

The biometric authentication module 104b may incorporate advanced error correction and noise reduction techniques to improve the quality of biometric data. In some implementations, the module may utilize adaptive filtering algorithms to remove environmental noise from audio samples in voice recognition, or image enhancement techniques such as contrast adjustment and deblurring for facial and fingerprint recognition. These preprocessing steps may enhance the reliability of biometric matching, particularly in challenging environmental conditions.

The module may implement multi-factor biometric authentication, combining two or more biometric modalities to increase security. For example, it may require both facial recognition and voice verification for high-security access scenarios. This approach may reduce the risk of false acceptances and provide a more robust authentication mechanism.

In some cases, the biometric authentication module 104b may employ behavioral biometrics in addition to physiological biometrics. This may include analyzing typing patterns, mouse movements, or even gait recognition through smartphone accelerometer data. The integration of behavioral biometrics may provide a less intrusive form of continuous authentication throughout a user session.

The module may utilize advanced data compression techniques to reduce the storage requirements for biometric templates. In some implementations, it may employ dimensionality reduction algorithms such as Principal Component Analysis (PCA) or t-Distributed Stochastic Neighbor Embedding (t-SNE) to create compact representations of biometric features while preserving their discriminative power.

To address potential biases in biometric systems, the module may incorporate fairness-aware machine learning techniques. These algorithms may be designed to minimize disparities in recognition accuracy across different demographic groups, improving the overall equity and reliability of the authentication process.

The biometric authentication module 104b may implement a challenge-response mechanism to enhance liveness detection. For instance, it may prompt users to perform specific actions, such as blinking or smiling, during facial recognition to verify that the biometric sample is coming from a live person rather than a static image or video recording.

In some implementations, the biometric authentication module 104b may utilize federated learning techniques to improve its biometric models without compromising user privacy. This approach may allow the system to learn from biometric data across multiple devices or organizations while keeping the raw data decentralized and secure.

The biometric authentication module 104b may incorporate adaptive learning capabilities to continuously improve its performance over time. It may use techniques such as online learning or transfer learning to fine-tune its biometric models based on new data, adapting to gradual changes in a user's biometric characteristics or environmental conditions.

To enhance security, the biometric authentication module 104b may implement a zero-knowledge proof protocol for biometric verification. This cryptographic technique may allow the system to verify a user's identity without actually storing or transmitting the raw biometric data, reducing the risk of data breaches or unauthorized access to sensitive biometric information.

The biometric authentication module 104b may also include a robust anomaly detection system to identify and flag unusual patterns in biometric authentication attempts. This system may use statistical analysis or machine learning algorithms to detect potential security threats, such as multiple failed authentication attempts or sudden changes in a user's biometric patterns.

The biometric authentication module 104b may also be designed with scalability and extensibility in mind. It may support the addition of new biometric modalities or improved algorithms through software updates, allowing the system to adapt to emerging technologies and evolving security requirements. In some implementations, the module may leverage cloud computing resources for computationally intensive tasks, balancing local processing for immediate responsiveness with cloud-based operations for more complex analyses.

A digital wallet module 112b containing an NFT verification engine 114b may be connected to both the biometric authentication module 104b and a blockchain network 120b. The blockchain network 120b may be represented as a cloud structure in the diagram.

The digital wallet module 112b may serve as a component in the biometric authentication and NFT access control system 100b. This module may be designed to manage and interact with various digital assets, including cryptocurrencies, tokens, and non-fungible tokens (NFTs). In some implementations, the digital wallet module 112b may utilize advanced cryptographic techniques to securely store private keys associated with a user's digital assets. These keys may be encrypted using strong algorithms such as AES-256, and may be further protected by hardware security modules (HSMs) for enhanced security.

The digital wallet module 112b may support multiple blockchain protocols, allowing users to manage assets across different networks such as Ethereum, Binance Smart Chain, or Solana. This multi-chain functionality may be achieved through the implementation of a unified interface that abstracts the complexities of individual blockchain interactions. To enhance user experience, the digital wallet module 112b may incorporate a user-friendly interface that displays asset balances, transaction histories, and NFT collections. This interface may utilize responsive design principles to ensure compatibility across various devices and screen sizes.

In some aspects, the digital wallet module 112b may incorporate advanced security features such as multi-signature functionality, allowing for distributed control of high-value assets. This may involve implementing threshold signature schemes that require multiple parties to approve transactions, reducing the risk of unauthorized asset transfers.

The digital wallet module 112b may also include real-time monitoring and alerting capabilities. It may utilize machine learning algorithms to detect unusual transaction patterns or potential security threats, alerting users and system administrators to suspicious activities.

To facilitate seamless integration with the biometric authentication module 104b, the digital wallet module 112b may implement secure APIs that allow for the association of biometric profiles with specific wallet addresses or NFTs. This integration may enable the system to perform granular access control based on both biometric verification and digital asset ownership.

The digital wallet module 112b may also support offline functionality through the implementation of state channel technologies. This may allow users to perform certain operations and verify asset ownership even in scenarios with limited or no internet connectivity.

In some implementations, the digital wallet module 112b may incorporate privacy-enhancing technologies such as zero-knowledge proofs. These cryptographic techniques may allow users to prove ownership or possession of certain digital assets without revealing specific details about those assets, enhancing user privacy in access control scenarios.

The digital wallet module 112b may also include features for asset management and portfolio analysis. It may implement algorithms to track asset valuations, provide investment insights, and even automate certain trading or rebalancing strategies based on predefined rules or machine learning models.

To ensure regulatory compliance, the digital wallet module 112b may incorporate built-in know-your-customer (KYC) and anti-money laundering (AML) checks. These features may utilize advanced identity verification techniques and transaction monitoring algorithms to maintain compliance with relevant financial regulations.

The digital wallet module 112b may be designed with extensibility in mind, allowing for the integration of future digital asset types or blockchain technologies through modular architecture and standardized interfaces. This flexibility may enable the system to adapt to the rapidly evolving landscape of digital assets and blockchain technologies.

The NFT verification engine 114b within the digital wallet module may play a key role in authenticating and validating NFT ownership. This engine may implement efficient algorithms to verify the authenticity of NFTs by querying the blockchain network 120b. It may utilize Merkle proof verification techniques to efficiently validate NFT ownership without the need to download the entire blockchain.

The NFT verification engine 114b may serve as a specialized component within the digital wallet module 112b, designed to authenticate and validate ownership of non-fungible tokens (NFTs). This engine may implement a range of advanced techniques to ensure efficient and secure verification of NFT ownership and authenticity.

In some implementations, the NFT verification engine 114b may utilize Merkle tree data structures to efficiently verify NFT ownership without the need to download and process the entire blockchain. This approach may involve constructing a Merkle tree of NFT ownership records, where each leaf node represents an individual NFT and its associated ownership data. The engine may then use Merkle proofs to validate the inclusion of specific NFTs within the tree, reducing computational overhead and improving verification speed.

The NFT verification engine 114b may incorporate multi-chain support, allowing it to verify NFTs across various blockchain networks. This functionality may be achieved through the implementation of blockchain-specific adapters that translate network-specific data structures and protocols into a standardized format for processing by the core verification logic.

To enhance security and prevent fraudulent NFT claims, the NFT verification engine 114b may implement cryptographic signature verification. This process may involve validating the digital signatures associated with NFT transfers and ownership claims against the public keys of known NFT marketplaces, creators, or previous owners. The engine may maintain a regularly updated database of trusted public keys to facilitate this verification process.

In some aspects, the NFT verification engine 114b may employ caching mechanisms to store frequently accessed NFT metadata and ownership information. This caching layer may help reduce the number of blockchain queries required for verification, improving response times and reducing network load. The cache may be periodically updated to ensure data freshness and accuracy.

The NFT verification engine 114b may also incorporate advanced metadata parsing and validation techniques. It may analyze the metadata associated with NFTs to verify their authenticity and integrity. This process may involve checking for expected data fields, validating file hashes of associated digital assets, and verifying links to off-chain storage solutions such as IPFS (InterPlanetary File System).

To address potential scalability challenges, the NFT verification engine 114b may implement batched verification processes. This approach may allow for the simultaneous verification of multiple NFTs in a single operation, improving efficiency when dealing with large collections or frequent verification requests.

The NFT verification engine 114b may include a reputation system for NFT contracts and marketplaces. This system may maintain a database of known reliable and fraudulent NFT sources, helping to quickly identify and flag suspicious NFTs during the verification process. The reputation data may be regularly updated based on community feedback and automated analysis of blockchain transactions.

In some implementations, the NFT verification engine 114b may support zero-knowledge proof protocols. These cryptographic techniques may allow for the verification of NFT ownership without revealing specific details about the NFT or its owner, enhancing privacy in certain use cases.

The NFT verification engine 114b may also incorporate machine learning algorithms to detect patterns indicative of fraudulent NFTs or unusual ownership transfers. These algorithms may analyze factors such as transaction history, wallet behavior, and metadata characteristics to flag potentially suspicious NFTs for further review.

To ensure compatibility with evolving NFT standards, the NFT verification engine 114b may be designed with a modular architecture. This approach may allow for the easy integration of new verification methods and support for emerging NFT formats through software updates, future-proofing the system against rapid developments in the NFT ecosystem.

The system 100b may also include a content access control module 116b that interfaces with both the biometric authentication module 104b and the digital wallet module 112b. The content access control module 116b may connect to a restricted content server 118b.

The content access control module 116b may serve as a central component in the biometric authentication and NFT access control system 100b, orchestrating the access decisions for restricted content based on inputs from various other modules. This module may implement a multi-factor decision-making process that combines biometric authentication results and digital asset ownership verification to determine user access rights.

In some implementations, the content access control module 116b may utilize a rule-based engine to evaluate access permissions. This engine may process complex sets of rules that define the relationships between biometric authentication levels, NFT ownership, and content access rights. The rules may be dynamically updatable, allowing for flexible and granular control over content access policies without requiring system-wide updates.

The content access control module 116b may incorporate a caching mechanism to store frequently accessed user permissions and content metadata. This caching layer may help reduce latency in access decisions by minimizing the need for repeated queries to the biometric authentication module 104b and digital wallet module 112b. The cache may be periodically synchronized with the authoritative data sources to ensure accuracy and freshness of access control information.

To enhance security, the content access control module 116b may implement a session management system. This system may generate and manage secure session tokens that encapsulate a user's authenticated state and verified permissions. These tokens may be cryptographically signed and time-limited to prevent unauthorized access through token theft or replay attacks.

The content access control module 116b may also include an audit logging component that records detailed information about access requests, decisions, and any anomalies detected during the access control process. These logs may be stored in a tamper-evident format, utilizing blockchain technology to ensure the integrity and non-repudiation of the audit trail.

In some aspects, the content access control module 116b may support fine-grained access control at the sub-content level. This functionality may allow for partial access to content based on specific NFT ownership or biometric authentication levels. For example, certain sections of a document or specific time ranges of a video may be accessible only to users who meet higher authentication thresholds or possess particular digital assets.

The content access control module 116b may implement adaptive access control mechanisms that adjust access rights based on contextual factors such as user location, device security status, or time of day. This adaptive approach may provide an additional layer of security by dynamically adjusting access permissions in response to changing risk factors.

To facilitate integration with various content delivery systems, the content access control module 116b may expose a set of APIs that allow external systems to query access rights and receive access control decisions. These APIs may support standard authentication and authorization protocols such as OAuth 2.0 or OpenID Connect, enabling seamless integration with existing content management and delivery platforms.

The content access control module 116b may incorporate a conflict resolution system to handle cases where different access control rules or NFT ownership states lead to ambiguous access rights. This system may implement predefined resolution strategies or escalate complex cases to human administrators for manual review.

In some implementations, the content access control module 116b may support delegated access control, allowing content owners or administrators to temporarily grant access rights to other users without transferring NFT ownership. This feature may be useful for collaborative workflows or time-limited content sharing scenarios.

The content access control module 116b may also include a simulation and testing component that allows administrators to model and validate complex access control policies before deploying them in production. This component may generate synthetic user profiles and access scenarios to comprehensively test the impact of policy changes on content accessibility.

To enhance user experience, the content access control module 116b may implement a feedback mechanism that provides clear explanations for access denials, including guidance on how users can obtain the necessary permissions or digital assets to gain access to desired content.

The content access control module 116b may be designed with high availability and fault tolerance in mind, utilizing distributed architectures and redundant components to ensure continuous operation even in the face of partial system failures. This robust design may help maintain consistent content protection and access control across various operating conditions.

The components may be arranged in a hierarchical structure, with the user device 102b at the top level connecting to the biometric authentication module 104b and digital wallet module 112b. The content access control module 116b and restricted content server 118b may be positioned at the lower level of the diagram.

The connections between components may be shown with solid and dashed lines, indicating different types of communication paths between the various modules and components of the system 100b. The dashed line connecting to the blockchain network 120b may suggest a network or wireless connection.

In operation, the system 100b may utilize biometric authentication in conjunction with NFT verification to control access to restricted content. The user device 102b may provide biometric data to the biometric authentication module 104b, which processes and verifies the user's identity. Simultaneously, the digital wallet module 112b may verify the user's ownership of specific NFTs through interaction with the blockchain network 120b. Based on the results of both the biometric authentication and NFT verification, the content access control module 116b may determine whether to grant the user access to content stored on the restricted content server 118b.

The biometric authentication process may involve several technical steps to verify a user's identity based on their unique biological characteristics. In some implementations, the process may begin with the capture of biometric data using specialized sensors or input devices. For example, a fingerprint scanner may utilize capacitive or optical technology to create a high-resolution image of a user's fingerprint ridges and valleys.

Once captured, the raw biometric data may undergo preprocessing to enhance its quality and extract relevant features. This step may involve techniques such as image enhancement, noise reduction, and segmentation. For instance, in the case of facial recognition, the system may apply algorithms to detect and isolate facial landmarks, normalize the image for variations in lighting and pose, and remove background elements.

Feature extraction may be a critical step in the authentication process. Advanced algorithms may be employed to identify and quantify distinctive characteristics of the biometric sample. In fingerprint authentication, this may involve detecting minutiae points such as ridge endings and bifurcations. For voice recognition, the system may extract spectral features using techniques like Mel-frequency cepstral coefficients (MFCCs) or linear predictive coding (LPC).

The extracted features may then be used to create a biometric template, which may be a compact mathematical representation of the user's biometric characteristics. This template may be designed to capture the essential identifying information while minimizing the storage of raw biometric data, enhancing both efficiency and privacy.

During the matching phase, the newly created template may be compared against one or more stored templates associated with the claimed identity. This comparison may utilize various matching algorithms, depending on the biometric modality and security requirements. For example, fingerprint matching may employ minutiae-based algorithms that compare the spatial relationships between minutiae points, while facial recognition may use deep learning models such as convolutional neural networks (CNNs) to compute similarity scores between facial features.

The matching process may generate a similarity score indicating the degree of correspondence between the presented biometric and the stored template. This score may then be evaluated against a predetermined threshold to make an authentication decision. The threshold may be adjustable based on the desired balance between security (false acceptance rate) and usability (false rejection rate).

In some implementations, the system may incorporate liveness detection techniques to prevent spoofing attempts. These may include analyzing micro-movements in facial recognition, detecting pulse or blood flow in fingerprint scans, or requesting specific actions from the user during the authentication process.

Multi-factor biometric authentication may be implemented by combining multiple biometric modalities or incorporating additional authentication factors. This approach may involve fusion techniques at various levels, such as feature-level fusion or score-level fusion, to integrate information from different biometric sources and enhance overall system accuracy and reliability.

The entire authentication process may be secured using encryption and secure communication protocols to protect biometric data in transit and at rest. Additionally, template protection schemes such as cancelable biometrics or biometric cryptosystems may be employed to safeguard stored biometric information and allow for revocation or replacement of compromised templates.

In some implementations, the system may verify a user's possession of a non-fungible token (NFT) through a multi-step process that leverages blockchain technology and cryptographic principles. The NFT verification engine 114b within the digital wallet module 112b may play a role in this verification process.

The verification process may begin when a user attempts to access restricted content that requires ownership of a specific NFT. The system may first request the user's blockchain wallet address, which may be stored in the digital wallet module 112b or provided by the user through the user device 102b.

Once the wallet address is obtained, the NFT verification engine 114b may query the blockchain network 120b to retrieve the list of NFTs associated with that address. This query may be performed using blockchain-specific APIs or by directly interacting with blockchain nodes.

The NFT verification engine 114b may then parse the retrieved data to identify the specific NFT required for content access. This process may involve checking the NFT's unique token ID, smart contract address, and other metadata stored on the blockchain.

To ensure the authenticity of the NFT, the verification engine may validate the NFT's provenance by tracing its transaction history on the blockchain. This may involve verifying that the NFT was minted by a recognized creator or platform and that the chain of ownership leads to the user's wallet address.

In some cases, the system may implement additional verification steps to prevent potential exploits. For example, it may check that the NFT has not been listed for sale on any marketplaces, which could indicate that the user no longer has full control over the asset.

The NFT verification engine 114b may also verify the integrity of the NFT's metadata by comparing the on-chain data with any off-chain storage references, such as IPFS (InterPlanetary File System) links. This step may help ensure that the NFT's associated digital content or attributes have not been altered.

For enhanced security, the system may require the user to sign a message with their private key corresponding to the wallet address. This cryptographic signature may serve as proof of control over the wallet and, by extension, ownership of the NFTs it contains.

In some implementations, the verification process may utilize zero-knowledge proofs to allow users to prove ownership of an NFT without revealing their entire wallet contents or transaction history. This approach may enhance user privacy while still providing robust verification.

The NFT verification engine 114b may cache verification results for a limited time to improve system performance and reduce the load on the blockchain network. However, the cache may be frequently updated to account for potential NFT transfers or blockchain reorganizations.

Upon successful verification of NFT ownership, the NFT verification engine 114b may communicate the result to the content access control module 116b, which may then use this information in conjunction with other factors, such as biometric authentication results, to make the final access control decision.

This integrated approach offers enhanced security and flexibility in content access control, leveraging both the uniqueness of biometric data and the immutability of blockchain-based assets. The system allows for granular access control based on specific NFT ownership, enabling new models for content distribution and monetization.

The disclosed methods and systems provide enhanced security through novel and unconventional multi-factor authentication. The system may combine biometric authentication with blockchain-based NFT verification, creating a more robust and secure authentication mechanism. This multi-factor approach may significantly reduce the risk of unauthorized access compared to traditional single-factor authentication methods. By requiring both a biometric match and proof of NFT ownership, the system may effectively mitigate various attack vectors, such as stolen credentials or spoofed biometric data.

The disclosed methods and systems provide improved privacy protection. In some implementations, the system may utilize advanced cryptographic techniques like zero-knowledge proofs for NFT verification. This approach may allow users to prove ownership of required digital assets without revealing their entire wallet contents or transaction history. Similarly, the biometric authentication process may employ template protection schemes such as cancelable biometrics or biometric cryptosystems. These methods may enhance user privacy by minimizing the exposure of sensitive personal and financial information during the authentication process.

The disclosed methods and systems provide scalable and flexible access control. The integration of NFTs into the authentication process may enable more granular and dynamic access control policies. Content providers may issue different types of NFTs representing various access levels or permissions, allowing for highly customizable and easily updatable access control schemes. This flexibility may be particularly valuable in scenarios requiring fine-grained control over content distribution or time-limited access rights.

The disclosed methods and systems reduce computational overhead. The system may implement efficient caching mechanisms for both biometric templates and NFT verification results. This caching strategy may significantly reduce the computational overhead and network load associated with repeated authentication requests. By storing frequently accessed data locally or in distributed caches, the system may achieve faster response times and improved scalability, particularly in high-traffic scenarios.

The disclosed methods and systems provide enhanced fraud detection and prevention. The combination of biometric data and blockchain-based asset verification may provide a powerful tool for detecting and preventing fraudulent access attempts. The system may leverage machine learning algorithms to analyze patterns in biometric data and NFT transactions, identifying anomalous behavior that could indicate attempted fraud. This proactive approach to security may represent an improvement over traditional reactive security measures.

The disclosed methods and systems provide improved interoperability and standardization. By utilizing blockchain technology for NFT verification, the system may promote greater interoperability between different content platforms and authentication systems. The use of standardized blockchain protocols and smart contracts for managing access rights may facilitate easier integration with existing content management systems and digital marketplaces. This interoperability may lead to more efficient and seamless user experiences across various platforms and services.

The disclosed methods and systems provide novel and unconventional adaptive authentication mechanisms. The system may implement adaptive authentication techniques that adjust security requirements based on contextual factors such as user behavior, device characteristics, or risk levels. This dynamic approach may optimize the balance between security and user experience, reducing friction for low-risk interactions while enforcing stricter authentication measures for high-value transactions or sensitive content access.

The disclosed methods and systems provide decentralized and tamper-resistant record keeping. The use of blockchain technology for storing NFT ownership and transaction history may provide a decentralized and tamper-resistant record of access rights. This feature may enhance the overall security and auditability of the authentication system, reducing the risk of centralized data breaches or unauthorized modifications to access control records.

The disclosed methods and systems provide efficient revocation and update mechanisms. The system may leverage the programmable nature of NFTs and smart contracts to implement efficient revocation and update mechanisms for access rights. This capability may allow content providers to quickly respond to security incidents or changes in access policies without requiring extensive system-wide updates.

The disclosed methods and systems provide an improved user experience through seamless authentication. By combining biometric authentication with NFT verification, the system may offer a more seamless and user-friendly authentication experience. Users may authenticate themselves using natural biometric traits while simultaneously proving ownership of required digital assets, eliminating the need for manual input of complex passwords or cryptographic keys.

These technical improvements individually and collectively represent a significant advancement in computing technology related to user authentication and access control systems. The novel combination of biometric verification and blockchain-based asset validation addresses limitations in existing authentication methods, offering enhanced security, privacy, and flexibility in managing access to digital content and services.

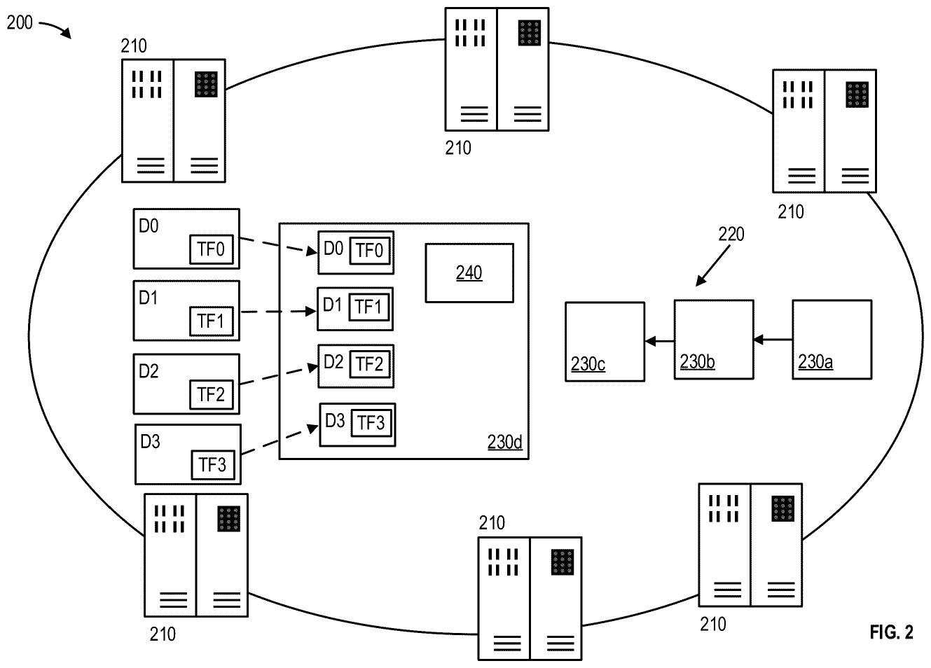

FIG. 2 shows an example blockchain system 150. The blockchain system 150 may comprise a network 200 of nodes 210. Each node 210 may comprise a computing device, a central processing unit, a graphical processing unit, a field programmable gate array, or an application-specific integrated circuit. In an example, each node 210 may comprise a content distribution device, such as a cable modem, set-top box, lap top, smart phone, tablet, wearable computing device, mobile computing device, or any computing device in communication with a content distribution network.

In an example, the network 200 of nodes 210 may comprise a decentralized database. The decentralized database may not have a central administrator or centralized storage. For example, each node 210 in the network 200 may store a copy of a collection of data, such as a distributed ledger. A distributed ledger may comprise a list of recorded entries, such as transactions. The data may be replicated, shared, or synchronized across the nodes 210. The decentralized database may be continually reconciled, such as to reflect changes to the collection of data. The nodes 210 may continually or periodically download the most recent version of the collection of data. When a node 210 joins the network 200, the node 210 may automatically download the collection of data.

A decentralized database, such as a distributed ledger, may comprise a blockchain 220. The decentralized database, such as the distributed ledger, may comprise a blockchain database and/or utilize blockchain data management techniques. A blockchain 220 may comprise one or more blocks 230 in which data is recorded. The blocks 230 in the blockchain 220 may function as a mechanism to organize the data in the blockchain 220. For example, the blocks 230 may be linked in a sequence determined by a relationship of the data in the blocks 230, such as the chronology in which the data is recorded or validated. The blocks 230 may be linked to deter retroactive modification of data in the blockchain 220.

The nodes 210 in the network 200 may build the blockchain 220, such as by adding blocks 230 to the blockchain 220. The nodes 210 may perform several operations to build the blockchain 220. For example, when new data D0, D1, D2, D3 is received by the network 200, the nodes 210 may validate the new data D0, D1, D2, D3. As an example, if the new data D0, D1, D2, D3 comprises transactions, the nodes 210 may validate, verify, or authenticate the identity of the parties to the transaction. A transaction may comprise a public key (or biometric information) of a party to the transaction and a digital signature of the party to the transaction. The digital signature may comprise the hash of transaction data, such as with a cryptographic hash function. The digital signature may comprise a hash of transaction data encrypted with a private key (or biometric information) corresponding to the public key (or unencrypted biometric information). Examples of hash functions include MD4, MD5, SHA-1, SHA-256, SHA-512, and SHA-3. The digital signature may be validated by the nodes 210, such as by decrypting the digital signature with the public key (or unencrypted biometric information). The digital signature may allow for verification of the transaction while maintaining the anonymity of the parties to the transaction.

The nodes 210 may collate the new data D0, D1, D2, D3 into a new block 230d. The nodes 210 may record one data entry D0 in a new block 230d. The nodes 210 may perform an operation to add the new block 230d to the blockchain 220. For example, if the data in the blocks 230 is related chronologically, such as where the first block 230a in the blockchain records older data than the data of subsequent blocks 230b, 230c, the nodes 210 may perform a timestamp function to log the sequence in which blocks 230 are added to the blockchain 220. The nodes 210 may append a hash of the previous block 230c to the new block 230d. The nodes 210 may insert an output of the previous block 230 in an input of the new block 230d. The chaining of the blocks, such as through iterative functions, may deter retroactive modification of data in a block 230 as the modification would require new functions to be performed for all of the subsequent blocks 230 in the blockchain 220.

The nodes 210 may perform the operation to add a new block 230d to the blockchain 220. For example, the block 230d may be associated with a digital asset such as a non-fungible token (NFT) or a digital currency. In one example, a block 230d may be assigned a token 240, such as a NFT that will be transferred to one or more nodes 210 that perform all or part of the operation. In another example, a block 230d may be assigned a value 240, such as a coin or unit of digital currency that will be transferred to one or more nodes 210 that perform part or all of the operation. A digital currency may comprise a cryptocurrency, such as Bitcoin, Litecoin, TorCoin, Ethereum, etc. The value 240 may depend on the difficulty of performing the operation for the block 230d. Also, if the data D0, D1, D2, D3 recorded in a block 230d comprises transactions, a transaction may assign a transaction fee TF0, TF1, TF2, TF3 which may be transferred to one or more nodes 210 that perform the operation on the block 230d in which the transaction is recorded. If a smart contract is provided for nodes 210 to perform the operation to add the new block 230d, performance of the operation may be referred to as minting. Minting may comprise creating a unit of a digital asset such as a NFT and distributing the unit to the nodes 210. If an incentive is provided for nodes 210 to perform the operation to add the new block 230d to the blockchain 220, performance of the operation may be referred to as mining. Mining may comprise creating one or more new units or partial units of the cryptocurrency or other value stored platform and distributing the one or more new units or partial units to the nodes 210 engaged in mining. The one or more new units or partial units of the cryptocurrency or other value stored platform may be created at a predetermined interval. The one or more new units or partial units of the cryptocurrency or other value stored platform may be assigned randomly (e.g., as in a lottery, etc.) to nodes 210 engaged in mining. Cryptocurrency or other value stored platform may be used as a gauge for productive and/or reliability (or proof of stake) among the nodes 210. For example, a validated transaction may not be added to a block 230a, 230b, 230c, 230d if a proof of work (e.g., the computing power used to find a nonce to hash with the block 230a, 230b, 230c, 230d) associated with the transaction is at and/or above a threshold number of digits.

Once the operation is performed to add a new block 230d to the blockchain 220, the nodes 210 may communicate the new block 230d to the network 200. The nodes 210 may express their acceptance of the new block 230d to the blockchain 220 by working off the block 230d when performing the operation to add a subsequent block to the blockchain 220. If more than one version of the blockchain 220 exists, the nodes 210 may attempt to work off the longest blockchain 220. The longest blockchain 220 may be determined by an algorithm for scoring the blockchain 220. For example, a blockchain 220 may be assigned a score based on the computational work required to create the blockchain 220. A node 210 may communicate the longest blockchain 220 that the node 210 has observed to the network 200, such as with a gossip protocol.

The network 200 may have self-correcting mechanisms, such as to address discrepancies between nodes 210 in the network 200. For example, if there is a fork in a blockchain 220, a node 210 working off one branch of the blockchain 220 may switch to a second branch of the blockchain 220, if the second branch becomes longer than the first branch. As an example, if a node 210 does not receive a block 230b, the node 210 may request the block 230b when the node 210 receives the next block 230c and determines that the node 210 did not receive the previous block 230b.

One or more nodes 210 in the network 200 may not participate in building the blockchain 220. The operations that the nodes 210 in the network 200 may perform relating to the blockchain may not be limited to building the blockchain 220. As an example, one or more nodes 210 may monitor the blockchain 220 for particular transactions. For example, the nodes 210 may monitor the blockchain 220 for transactions that comprise an identifier associated with a party.

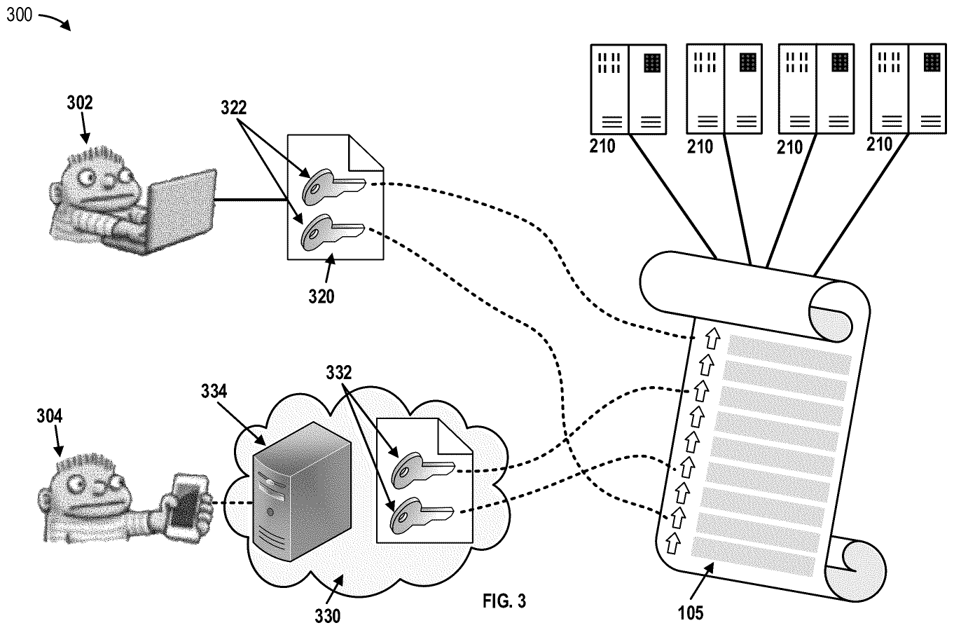

FIG. 3 shows an example blockchain network environment 300 in which wallet transactions are recorded in the blockchain 105. Blockchain digital assets such as NFTs or digital currency, may be managed according to an individual's, or user's, 302, 304 digital wallet 320, 330. Digital wallets 320, 330 let users send or receive digital assets (e.g., NFTs, digital currency, etc.), calculate the total balance of addresses in use, and generate new addresses as needed. Digital wallets 320, 330 may include precautions to keep the private keys secret, for example, by encrypting the wallet data with a password or by requiring two-factor authenticated logins.

Digital wallets 320, 330 may be configured to provide one or more of: storage of digital currency addresses and corresponding public/private keys on the user's computer in a wallet.dat file; an ability to conduct transactions of obtaining and transferring digital assets, also without connection to the Internet, for example; and provide information about the virtual balances in all available addresses, prior transactions, spare keys, etc. Digital wallets 320, 330 may be implemented as stand-alone software applications and/or web applications. In one example, user 302 may access his/her digital wallet 320 via a stand-alone software application. In another example, user 304 may access his/her digital wallet 332 via a web application via a server, a cloud device, 334. The users 302, 304 may access the digital wallets 320, 330 via a user device such as a laptop, smart phone, tablet computer, etc. The digital wallets 320, 332 may include private keys associated with the digital wallets 320, 330 and/or blockchain addresses 322, 332 associated with the digital assets included in each digital wallet 320, 330. The private keys 320, 330 may be recorded/stored in the blockchain ledger 105, wherein the ledger 105 may be stored in each of the nodes 210.

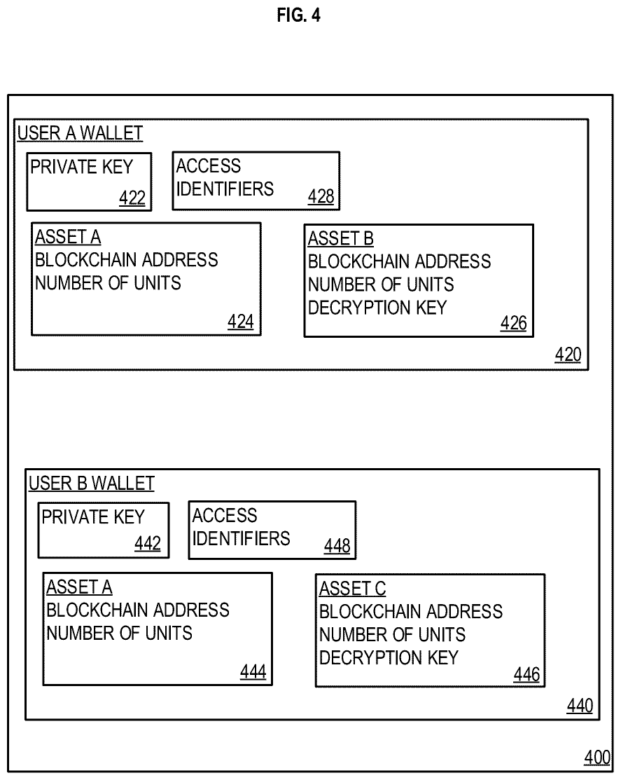

FIG. 4 shows example user wallets that may be stored in the wallet memory 400 (e.g., wallet memory 151). The wallet memory 400 may include digital wallets such as user A wallet 420 and user B wallet 440. Each digital wallet 420, 440 may be associated with a different individual. A different private key (e.g., 422 and 442), or wallet address, may be recorded in, or may be recorded in association with, each digital wallet. In addition, access identifiers 428, 448 may be generated and associated with the digital wallet 420, 440 and/or the wallet address of the digital wallet based on an owner of the digital wallet being granted/provided access to one or more content assets. For example, the owner of the digital wallet may be granted access to a content asset based on owning one or more required digital assets (e.g., in the digital wallet). The asset identifiers 428, 448 may be associated with the digital wallet 420, 440 and/or the wallet address based on the one or more required digital assets included in the digital wallet 420, 440. As described above, the private key, or wallet address, may be used in generating the transactions relating to each digital wallet 420, 440, and may be recorded in the blockchain (e.g., the blockchain in the blockchain system 105).

As shown in FIG. 4, user A wallet 420 may include information regarding two assets (e.g., asset A and asset B). A blockchain address and, optionally, a number of units of the asset may be recorded for each of asset A (memory area 424) and asset B (memory area 426) in user A's digital wallet 420. In addition a decryption key may be recorded for asset B. For example, asset B may be associated with a NFT owned by user A. Access to a content asset may be provide to user A based on asset B in the digital wallet 420. Based on being provided access to the content asset based on asset B in the digital wallet 420, a decryption key may be associated with the digital wallet 420 and a record of the decryption key may be recorded in the blockchain. The number of units information may be determined from the blockchain and, for example, may be stored in, or in association with, the corresponding digital wallet (e.g., in order to reduce the need to access the blockchain for obtaining frequently used information). Similarly, user B wallet 440 may include information regarding two assets (e.g., asset A and asset C). A blockchain address and, optionally, a number of units of the asset may be recorded for each of asset A (memory area 444) and asset C (memory area 446) in user wallet 440. In addition, a decryption key may be recorded for asset C. As discussed above, access to a content asset may be provided based on asset C in the digital wallet 440 and the decryption key may be associated with the digital wallet 440. A record of the decryption key may be recorded in the blockchain. The number of units information may be determined from the blockchain and, for example, may be stored in, or in association with, the corresponding digital wallet (e.g., in order to reduce the need to access the blockchain for obtaining frequently used information). As an example, the number of units of the digital asset indicated in the issuer wallet for asset A may have initially been recorded in the blockchain by a transaction as the total number of units of that digital asset. Subsequent transactions may assign units of the digital asset to each owner of digital asset A according to ownership specified in an ownership ledger in the blockchain. For example, each such subsequent transaction may result in adding a number of units of the digital asset to an asset owner's digital wallet according to the ownership specified in the ownership ledger, and may result in deducting that number of units of the digital asset from the issuer's digital wallet.

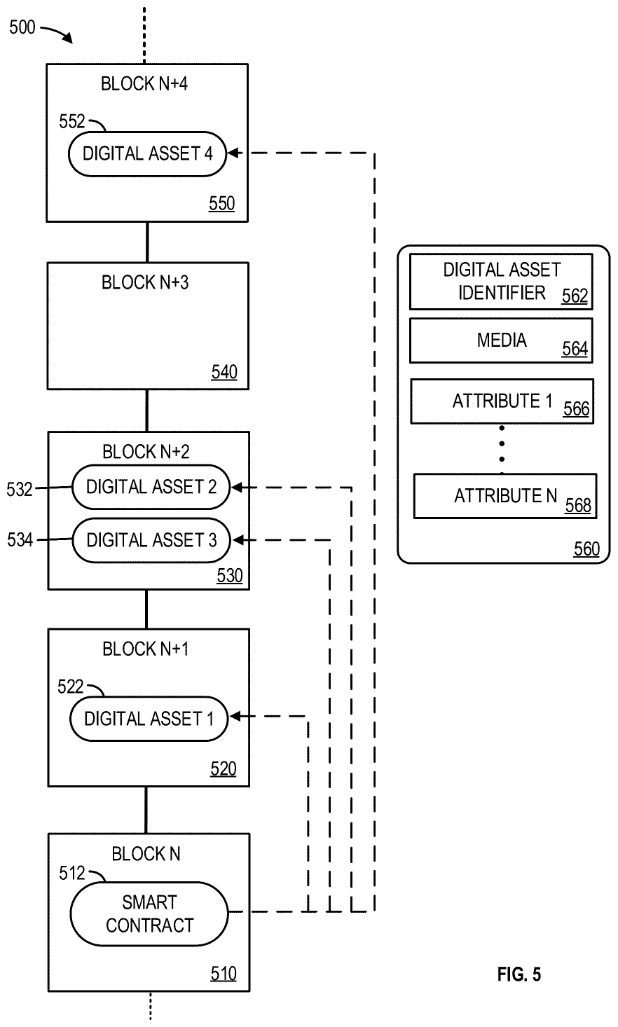

FIG. 5 shows an example blockchain network environment 500. A smart contract 510 may be implemented within the blockchain network 500. In an example, the smart contract 510 may be executable code recorded in the blockchain 500 and may include functions that are available for execution by having those functions called in subsequent transactions. In an example, the smart contract 512 may relate to digital asset (e.g., NFT) generation and/or management. That is, the smart contract 512 may include functions for minting digital assets, determining/validating ownership of those digital assets, transferring ownership of those digital assets from a current valid owner to a new owner, and conditions for accessing one or more content assets (e.g., a single content asset and/or a collection of content assets). In an example, ownership of a digital asset may be associated with an address (e.g., a public key) such as a wallet address of a digital wallet. In an example, ownership of a digital asset may be based on the digital asset's association with a biometric user profile of a user. A computing device that holds the corresponding private key may be used to authenticate the computing device as the owner of that public key, thereby enabling the computing device to take actions with respect to a digital asset included in the digital wallet, such as transferring it to a different public key. In an example, a computing device that holds biometric information, or a biometric user profile, of a user may be used to authenticate the computing device as a computer device of the user, thereby enabling the computing device to take actions with respect to a digital asset associated with the user's biometric user profile.

In an example, when the smart contract 512 is used to mint digital assets, the minting and ownership data for that digital asset may be recorded on the blockchain 500, as indicated by 512, 522, 532, 534, and 552 in blocks 510, 520, 530, and 550. In an example, the digital asset data 560 recorded in the blockchain 500 may include a unique digital asset identifier 562. In an example, the digital asset data 560 recorded in the blockchain may include one or more media files 564 or URI link(s) to one or more media files 564 that are the subject of the digital asset. The media files 564 may include, for example, an image file, a video file, an audio file, combinations thereof, and the like. The digital asset data 560 may further include one or more digital asset attributes 566-568. The digital asset attributes may include contextual information regarding the digital asset, such as a minting date, a category, data regarding the features or characteristics of the media file 564, or any other such attributes of the subject matter of the digital asset.

The digital assets 522, 532, 534, 552 minted and managed by the smart contract 512 may be considered part of a collection of digital assets in that they are all governed by the same smart contract 512. In an example, a collection of digital assets may be minted using different smart contracts or using non-blockchain code for generation of the digital assets and off-chain software for causing the digital assets to be recorded in the blockchain 500 in blockchain transactions. These digital assets may be considered part of a single collection of digital assets if they are linked in such a manner as to form a collection, such as having a link or reference within each digital asset identifying those digital assets as belonging to a specific collection. In an example, the digital asset collection may have a single digital asset.

The smart contract 510 may further indicate digital assets that a user must own (e.g., included in the user's/owner's digital wallet or associated with a user's biometric user profile) in order to access a content asset. For example, an individual may be required to own a required digital asset in order to gain access to a corresponding content asset. As an example, the smart contract may specify that an individual content asset (e.g., movie, image, video, audio, etc.) or a collection of content assets (e.g., all access pass, behind the scenes access, series, group of images, group of audio content, etc.) may be accessed based on specified digital assets. For example, a user may access either the individual content asset or the collection of content assets based on the digital assets owned by the user (e.g., in the user's digital wallet). The smart contract 510 may further specify that if a user does not have the required digital asset for accessing a desired content asset, the user may be provided with an option to purchase the required digital asset. Once the user purchases the required digital asset and it is added to the user's digital wallet, the digital asset is associated with the individual's biometric user profile, the individual may be granted access to the corresponding content asset.

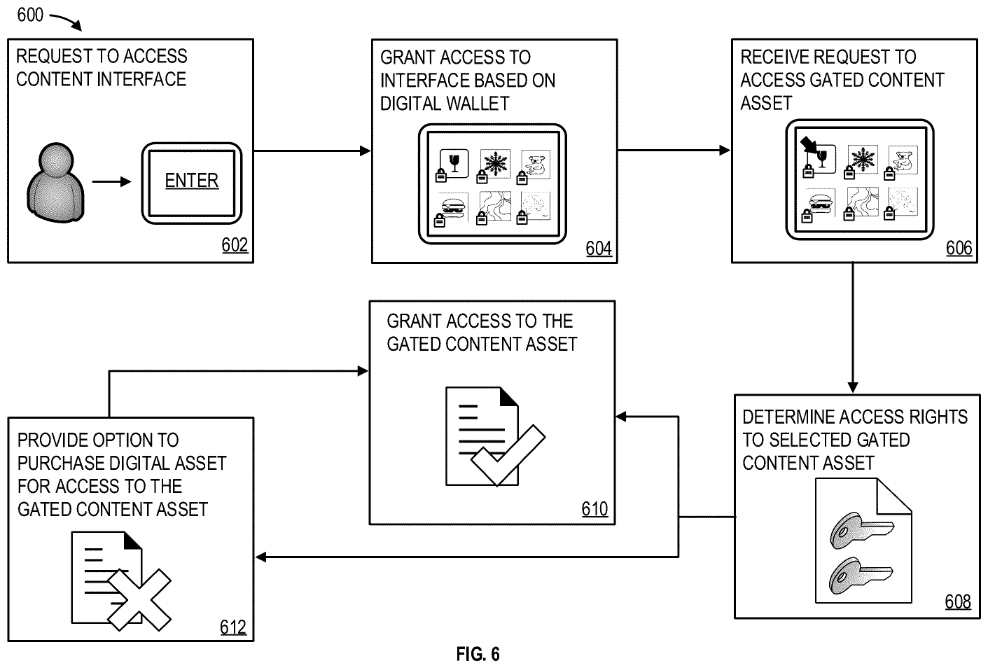

FIG. 6 shows a flowchart of an example method 600 for implementing a smart contract. At 602, a user may request access to a content interface (e.g., webpage, user application, VR/AR interface, etc.). For example, the request may include the wallet address of a digital wallet owned by the user, or the user may enter the wallet address of the digital wallet when logging onto the interface. In an example, the user's biometric information may be collected when the user requests access to the content interface. The biometric information may be associated with a biometric user profile associated with the user.

At 604, the user may be granted access to the interface based on the wallet address of the digital wallet. The interface may authenticate the user as the owner of the digital wallet, wherein the digital wallet may be used to validate the user as the owner of the digital assets included in the digital wallet. For example, access to the interface may be granted based on one or more of a QR code of the interface, a wallet extension associated with the digital wallet, a hard wallet associated with the digital wallet, physical biometric data associated with the digital wallet, or behavioral biometric data associated with the digital wallet. The physical biometric data may comprise one or more of a fingerprint, palm veins, facial features, DNA, a palm print, hand geometrics, iris recognition, voice, or gait. The behavioral biometric data may comprise one or more of continuous authentication, keystrokes associated with a user device, location data, or lip movements.

At 606, a user may request access to a gated content asset. For example, one or more content assets (e.g., movies, images, videos, audios, etc.) or one or more collections of content assets (e.g., behind the scenes access, series, group of images, group of audio content, etc.) may be provided/displayed as options for the user to select from. A smart contract may be used to manage access to the gated content asset.

At 608, the user's access rights may be determined for the selected gated content asset or collection of content assets. For example, a smart contract associated with the interface, gated content asset, or gated collection of assets may indicate that access may be granted to the gated content asset or gated collection of content assets based on the digital wallet of the user including one or more digital assets (e.g., NFTs). In an example, the user's access rights may be determined after being granted access to the interface. For example, the user's access rights may be determined for each gated content asset or each gated collection of content assets. The interface may determine whether the user has one or more required digital assets included in the user's digital wallet in order to determine the user's access rights for each gated content asset or each gated collection of content assets. In an example, the interface may output/display an indication of whether the user has access rights to each gated content asset or each gated collection of content assets.

In an example, the user's biometric information may be used to identify/determine the user's biometric user profile. The digital assets may be associated with the user's biometric user profile instead of, or in addition to, being included in the user's digital wallet. For example, the user's biometric information may be collected when the user purchases one or more of the digital assets used for facilitating access to the content assets. The biometric user profile for the user may be generated based on the user's biometric information. The user may be granted access to the content assets based on whether the user has the required digital assets associated with the user's biometric user profile.

In an example, the user's biometric user profile may simply be used for accessing the content asset. For example, the user's biometric information may be collected when the user purchases access to the content assets. The biometric user profile for the user may be generated based on the user's biometric information. The subscriptions to the content assets may be associated with the user's biometric user profile. The user may be granted access to the content assets based on whether the user's biometric user profile is associated with subscriptions to the content assets.

At 610, based on the digital wallet of the user including one or more of the required digital assets, the user may be granted access to the selected gated content asset or gated collection of content assets. In an example, based on the user's biometric user profile being associated with one or more of the required digital assets, the user may be granted access to the selected gated content asset or gated collection of content assets. In an example, based on the user's biometric user profile being associated with a subscription to the selected gated content asset or gated collection of content assets, the user may be granted access to the selected gated content asset or gated collection of content assets.

At 612, if the user does not have any of the required digital assets included in the user's digital wallet, or the user's biometric user profile is not associated with any of the required digital assets, the user may be provided options for purchasing one or more of the required digital assets. Once the user purchases one or more of the required digital assets and the digital asset(s) is/are added to the user's digital wallet, or the digital asset(s) is/are associated with the user's biometric user profile, the user may be granted access to the corresponding gated content asset or gated collection of content assets.

In an example, the content assets may be encrypted. Based on granting access to at least one of the content assets or collection of content assets, a decryption key for the corresponding content asset or decryption keys for the corresponding collection of content assets may be associated with the digital wallet, or the biometric user profile. For example, the decryption key(s) may be stored at a server associated with the interface or at a third party provider. In an example, the decryption key may(s) be separated (e.g., broken) into a plurality of portions and stored across a blockchain network. As an example, decryption key(s) may be associated with the wallet address of the digital wallet. The user's user device may access the decryption key(s) based on the association with the wallet address, or the biometric user profile, in order to stream the corresponding content asset(s).

In an example, based on granting access to at least one of the content assets, one or more identifiers may be generated. The one or more identifiers may comprise one or more of a unique user identifier associated with an owner of the digital wallet or a user of the biometric user profile, a forensic watermark, metadata, or software codes associated with the digital wallet. In an example, the one or more identifiers may be associated with the wallet address of the digital wallet for facilitating access to the selected content asset or collection of content assets. The user associated with the digital wallet may access the selected content asset or collection of content assets based on the one or more identifiers. In an example, the one or more identifiers may be embedded in one or more of the interface (e.g., display of the interface) or the at least one content asset (e.g., digital rights management (DRM) protection). The interface and/or the at least one content asset embedded with the one or more identifiers may be unique for each user that accesses the content asset. For example, DRM may be used to prevent the unauthorized access to the content asset, such as by preventing the sharing of a URL of the content asset to an unauthorized individual and by preventing an unauthorized individual from recording the content asset. In an example, the one or more identifiers may be stored, or associated with the wallet address and subsequently embedded (e.g., imperceptibly or visibly) into the content asset as each time the content asset is output via the interface. For example, an identifier may comprise an indication or image of the digital asset (e.g., NFT), an indication or image of the wallet address, or an indication or image of both the digital asset and the wallet address. The indication/image may be embedded, imperceptibly or visibly, onto a portion of the content asset. The indication/image may be tracked each time the digital asset is output. For example, if a user attempts to share the content asset or the content asset is leaked without authorization, the identifier may be tracked as the content asset is being output. Thus, the unauthorized access of the content asset may be traced back to the digital wallet (e.g., via the embedded NFT or the embedded wallet address) that provided/leaked the content asset without authorization.

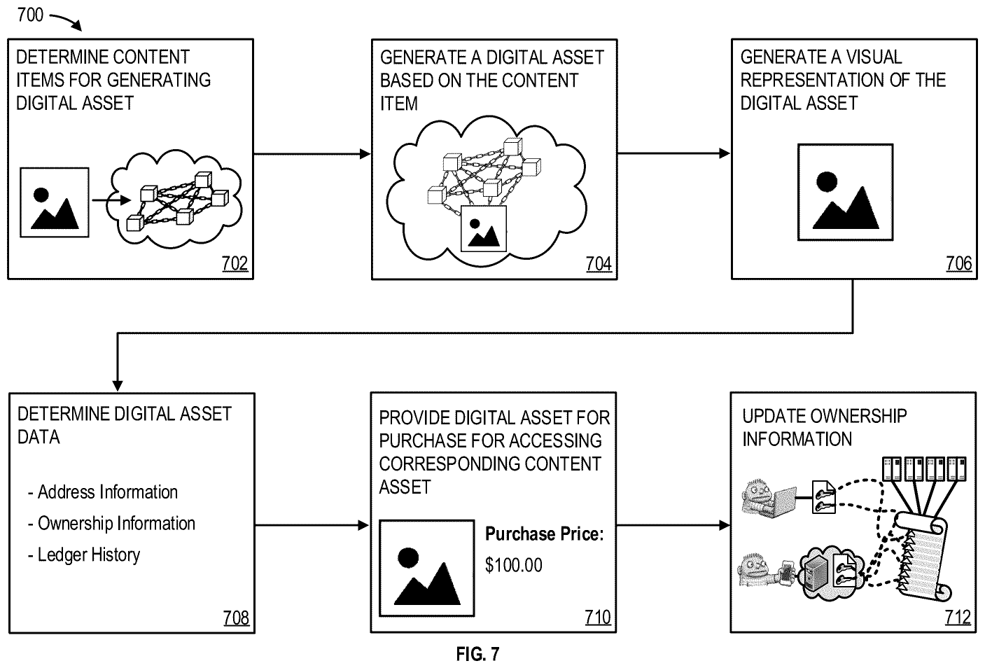

FIG. 7 shows a flowchart of an example method 700 for generating (e.g., minting) and managing digital assets (e.g., NFTs) according to a smart contract. At 702, one or more content items may be determined for generating a digital asset. For example, the digital assets, or NFTs, may be generated based on one or more images, videos, audio data, combinations thereof, etc. For example, a smart contract may include a digital asset requirement for accessing one or more content assets or one or more collections of content assets. The smart contract may indicate that a user must own one or more digital assets (e.g., digital assets included in the user's digital wallet) in order to access one or more content assets or one or more collections of content assets.

At 704, the digital assets may be generated/minted based on the one or more content items (e.g., images, videos, audio data, combinations thereof, etc.). As an example, the smart contract may provide the functions for minting the digital assets required for accessing the content assets or collections of content assets. When the smart contract is used to mint digital assets (e.g., NFTs), the minting and ownership data for that digital asset may be recorded on the blockchain. In one example, the digital asset data recorded on the blockchain 105 may include a unique digital asset identifier. In another example, the digital asset data recorded on the blockchain may include one or more media files or uniform resource identifier (URI) link(s) to the one or more media files of the digital asset. The media files may comprise one or more of an image file, a video file, an audio file, combinations thereof, etc. The digital assets minted and managed by the smart contract may be considered part of a collection of digital assets in that they are all governed by the same smart contract. As an example, each content asset or each collection of content assets may be associated with a single smart contract that governs the required digital asset(s) for accessing the corresponding content asset or corresponding collection of content assets.

At 706, a visual representation of the digital asset (e.g., NFT) may be generated. For example, the visual representation may be generated based on the one or more content items (e.g., images, videos, audio data, combinations thereof, etc.). In an example, the visual representation may be embedded (e.g., imperceptibly or visibly) in an associated content asset when the digital asset is used to gain access to the content asset. For example, the content asset may comprise a plurality of frames, wherein the digital asset may be embedded into each frame of the content asset as the content asset is being output.

At 708, the digital asset data may be determined. For example, the digital asset data may include one or more of address information or location indicator (e.g., specifying a storage location or a contract address of the digital asset within a blockchain), digital asset name or title, ownership information, (e.g., user account information of a current owner of the digital asset), creator information (e.g., indicating a user account of a creator of the digital asset), and/or blockchain ledger history (e.g., indicating transfers of the digital asset between various owner accounts).

At 710, the digital assets may be provided for purchase for accessing the corresponding content assets. For example, each content asset or each collection of content assets associated with the interface (e.g., webpage, user application, VR/AR interface, etc.) may require the user accessing the interface to own one or more digital assets in order to access the corresponding content asset or collection of content assets. The user accessing the interface may purchase the required digital assets in order to gain access to the corresponding content asset or collection of content assets.

At 712, the ownership information may be updated based on the user's purchase of the digital asset. For example, the digital asset may be initially owned be an individual, or organization, that caused the digital asset to be minted. Once a subsequent user purchases the digital asset, the blockchain ledger may be updated to reflect the subsequent user as the new current owner of the digital wallet. In an example, the subsequent user's digital wallet may be updated to reflect the subsequent user's ownership of the digital asset. For example, the digital asset may be associated with a wallet address of the subsequent user's digital wallet.

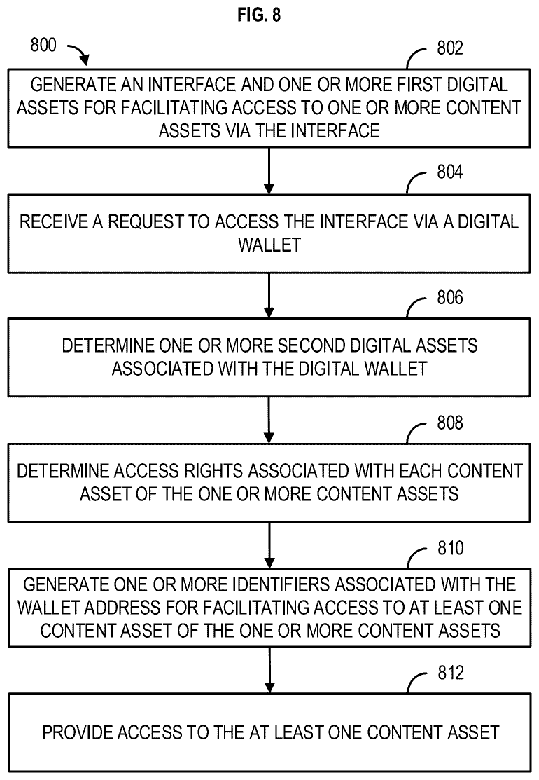

FIG. 8 shows a flowchart of an example method 800 of providing access to a content asset based on whether a user owns one or more digital assets (e.g., digital wallet contains one or more digital assets). The method may be implemented by one or more devices (e.g., server computing device 101, admin device 102, user devices 103, any combination thereof, etc.) or can be encoded into a smart contract. At step 802, an interface and one or more first digital assets for facilitating access to one or more content assets via the interface may be generated. For example, a device (e.g., server computing device 101, admin device 102, user devices 103, etc.) may generate the interface and the one or more first digital assets for facilitating access to the one or more content assets via the interface. The interface may comprise a webpage or a user application (e.g., installed on a user device). In an example, the interface may be formatted for virtual reality (VR) or augmented reality (AR). The one or more content assets may comprise one or more of image content, video content, or audio content. In an example, the one or more content assets may be stored on one or more of a server or a blockchain network. The one or more first digital assets may comprise one or more cryptocurrencies, one or more tokens, or one or more non-fungible tokens (NFTs).

At step 804, a request to access the interface via a digital wallet may be received. For example, the request to access the interface via the digital wallet may be received by the device (e.g., server computing device 101, admin device 102, user devices 103, etc.). The digital wallet may be associated with a wallet address. In an example, the request may include the digital wallet, or the wallet address of the digital wallet. The digital wallet may be associated with one or more second digital assets. In an example, the interface may authenticate a user as an owner of the digital wallet, wherein the digital wallet may be used to validate ownership (e.g., the user) of the one or more second digital assets. For example, access may be provided to the interface based on one or more of a QR code of the interface, a wallet extension associated with the digital wallet, a hard wallet associated with the digital wallet, physical biometric data associated with the digital wallet, or behavioral biometric data associated with the digital wallet. The physical biometric data may comprise one or more of a fingerprint, palm veins, facial features, DNA, a palm print, hand geometrics, iris recognition, voice, or gait. The behavioral biometric data may comprise one or more of continuous authentication, keystrokes associated with a user device, location data, or lip movements. As an example, a biometric user profile for identifying a user associated with the digital wallet may be generated based on one or more of the physical biometric data or the behavioral biometric data. In an example, each second digital asset of the one or more second digital assets may comprise identifying information of an owner (e.g., the user) of the one or more second digital assets.

At step 806, the one or more second digital assets associated with the digital wallet may be determined. For example, the device (e.g., server computing device 101, admin device 102, user devices 103, etc.) may determine the one or more second digital assets associated with the digital wallet. The one or more second digital assets may comprise one or more of one or more cryptocurrencies, one or more tokens, or one or more non-fungible tokens (NFTs).

At step 808, access rights associated with each content asset of the one or more content assets may be determined based on the one or more second digital assets and the one or more first digital assets. For example, the device (e.g., server computing device 101, admin device 102, user devices 103, etc.) may determine the access rights associated with each content asset of the one or more content assets based on the one or more second digital assets and the one or more first digital assets. In an example, based on at least one second digital asset of the one or more second digital assets matching at least one first digital asset of the one or more first digital assets, the access rights may be determined to indicate an owner (e.g., the user) of the digital wallet has access to the at least one content asset. In an example, based on at least one second digital asset of the one or more second digital assets not matching at least one first digital asset of the one or more first digital assets, the access rights may be determined to indicate an owner (e.g., the user) of the digital wallet does not have access to the at least one content asset.

At step 810, one or more identifiers associated with the wallet address for facilitating access to at least one content asset of the one or more content assets may be generated based on the access rights associated with each content asset. For example, the device (e.g., server computing device 101, admin device 102, user devices 103, etc.) may generate the one or more identifiers associated with the wallet address for facilitating access to the at least one content asset of the one or more content assets based on the access rights associated with each content asset. The one or more identifiers may comprise one or more of a unique user identifier associated with an owner of the digital wallet, a forensic watermark, metadata, or software codes associated with the digital wallet. In an example, the one or more identifiers may be generated based on the access rights indicating the owner (e.g., the user) of the digital wallet having access to the at least one content asset. In an example, based on the access rights indicating the owner (e.g., the user) of the digital wallet does not have access to the at least one content asset, an option to purchase at least one of the one or more first digital assets may be provided to the owner of the digital wallet (e.g., the user) accessing the interface. Based on the owner of the digital wallet (e.g., the user) purchasing the at least one of the one or more first digital assets, the access rights may be updated to indicate that the owner of the digital wallet (e.g., the user) has access to the at least one content asset. The one or more identifiers may be generated based on the updated access rights indicating the owner of the digital wallet (e.g., the user) having access to the at least one content asset.

At step 812, access may be provided to the at least one content asset based on the one or more identifiers. For example, the device (e.g., server computing device 101, admin device 102, user devices 103, etc.) may provide access to the at least one content asset based on the one or more identifiers. In an example, the one or more content assets may be encrypted. A decryption key may be associated with the wallet address of the digital wallet based on the one or more identifiers. The decryption key may be used by the owner of the digital wallet (e.g., the user) to decrypt the at least one content asset and access the content asset. In an example, the one or more identifiers may be embedded in one or more of the interface (e.g., display of the interface) or the at least one content asset (e.g., digital rights management (DRM) protection). The interface and/or the at least one content asset embedded with the one or more identifiers may be unique for each user that accesses the content asset. For example, DRM may be used to prevent the unauthorized access to the content asset, such as preventing the sharing of a URL of the content asset to an unauthorized individual and preventing an unauthorized individual from recording the content asset.

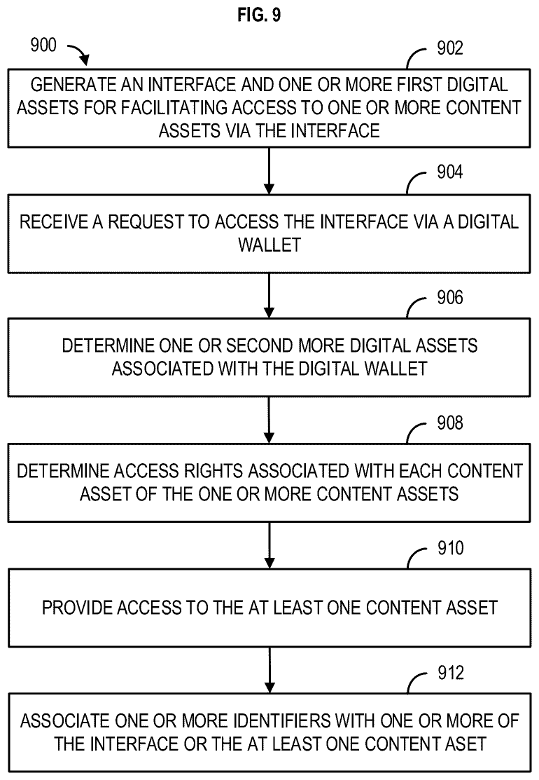

FIG. 9 shows a flowchart of an example method 900 of providing access to a content asset based on whether a user owns one or more digital assets (e.g., digital wallet contains one or more digital assets). The method may be implemented by one or more user devices (e.g., server computing device 101, admin device 102, user devices 103, or any combination thereof) or can be encoded into a smart contract. At step 902, an interface and one or more first digital assets for facilitating access to one or more content assets via the interface may be generated. For example, a device (e.g., server computing device 101, admin device 102, user devices 103, etc.) may generate the interface and the one or more first digital assets for facilitating access to the one or more content assets via the interface. The interface may comprise a webpage or a user application (e.g., installed on a user device). In an example, the interface may be formatted for virtual reality (VR) or augmented reality (AR). The one or more content assets may comprise one or more of image content, video content, or audio content. In an example, the one or more content assets may be stored on one or more of a server or a blockchain network. The one or more first digital assets may comprise one or more cryptocurrencies, one or more tokens, or one or more non-fungible tokens (NFTs).

At step 904, a request to access the interface via a digital wallet may be received. For example, the request to access the interface via the digital wallet may be received the device (e.g., server computing device 101, admin device 102, user devices 103, etc.). The digital wallet may be associated with a wallet address. In an example, the request may include the digital wallet, or the wallet address of the digital wallet. The digital wallet may be associated with one or more second digital assets. In an example, the interface may authenticate a user as an owner of the digital wallet, wherein the digital wallet may be used to validate ownership (e.g., the user) of the one or more second digital assets. For example, access may be provided to the interface based on one or more of a QR code of the interface, a wallet extension associated with the digital wallet, a hard wallet associated with the digital wallet, physical biometric data associated with the digital wallet, or behavioral biometric data associated with the digital wallet. The physical biometric data may comprise one or more of a fingerprint, palm veins, facial features, DNA, a palm print, hand geometrics, iris recognition, voice, or gait. The behavioral biometric data may comprise one or more of continuous authentication, keystrokes associated with a user device, location data, or lip movements. As an example, a biometric user profile for identifying a user associated with the digital wallet may be generated based on one or more of the physical biometric data or the behavioral biometric data. In an example, each second digital asset of the one or more second digital assets may comprise identifying information of an (e.g., the user) owner of the one or more second digital assets.

At step 906, the one or more second digital assets associated with the digital wallet may be determined. For example, the device (e.g., server computing device 101, admin device 102, user devices 103, etc.) may determine the one or more second digital assets associated with the digital wallet. The one or more second digital assets may comprise one or more cryptocurrencies, one or more tokens, or one or more non-fungible tokens (NFTs).

At step 908, access rights associated with each content asset of the one or more content assets may be determined based on the one or more second digital assets and the one or more first digital assets. For example, the device (e.g., server computing device 101, admin device 102, user devices 103, etc.) may determine the access rights associated with each content asset of the one or more content assets based on the one or more second digital assets and the one or more first digital assets. In an example, based on at least one second digital asset of the one or more second digital assets matching at least one first digital asset of the one or more first digital assets, the access rights may be determined to indicate an owner of the digital wallet has access to the at least one content asset. In an example, based on at least one second digital asset of the one or more second digital assets not matching at least one first digital asset of the one or more first digital assets, the access rights may be determined to indicate an owner of the digital wallet does not have access to the at least one content asset.

At step 910, access may be provided to at least one content asset of the one or more content assets based on the access rights associated with each content asset. For example, the device (e.g., server computing device 101, admin device 102, user devices 103, etc.) may provide access to the at least one content asset of the one or more content assets based on the access rights associated with each content asset. In an example, access to the at least one content asset may be provided based on the access rights indicating the owner of the digital wallet (e.g., the user) having access to the at least one content asset. In an example, based on the access rights indicating the owner of the digital wallet (e.g., the user) does not have access to the at least one content asset, an option to purchase at least one of the one or more first digital assets to the owner of the digital wallet (e.g., the user) accessing the interface. Based on the owner of the digital wallet (e.g., the user) purchasing the at least one of the one or more first digital assets, the access rights may be updated to indicate that the owner of the digital wallet (e.g., the user) has access to the at least one content asset. Access to the at least one content asset may be provided based on the updated access rights indicating the owner of the digital wallet (e.g., the user) having access to the at least one content asset. In an example, the one or more content assets may be encrypted. A decryption key may be associated with the wallet address of the digital wallet based on the access rights associated with each content asset. For example, the decryption key may be associated with the wallet address based on the access rights indicating the owner of the digital wallet having access to the at least one content asset. The decryption key may be used by the owner of the digital wallet to decrypt the at least one content asset and access the content asset.

At step 912, one or more identifiers may be associated with one or more of the interface or the at least one content asset based on providing access to the at least one content asset. For example, the one or more identifiers may be associated with one or more of the interface or the at least one content asset by the device (e.g., server computing device 101, admin device 102, user devices 103, etc.) based on providing access to the at least one content asset. The one or more identifiers may be associated with the wallet address. The one or more identifiers may comprise one or more of a unique user identifier associated with an owner of the digital wallet, a forensic watermark, metadata, or software codes associated with the digital wallet. In an example, the one or more identifiers may be embedded in one or more of the interface (e.g., display of the interface) or the at least one content asset (e.g., digital rights management (DRM) protection). The interface and/or the at least one content asset embedded with the one or more identifiers may be unique for each user that accesses the content asset. For example, DRM may be used to prevent the unauthorized access to the content asset, such as preventing the sharing of a URL of the content asset to an unauthorized individual and preventing an unauthorized individual from recording the content asset.

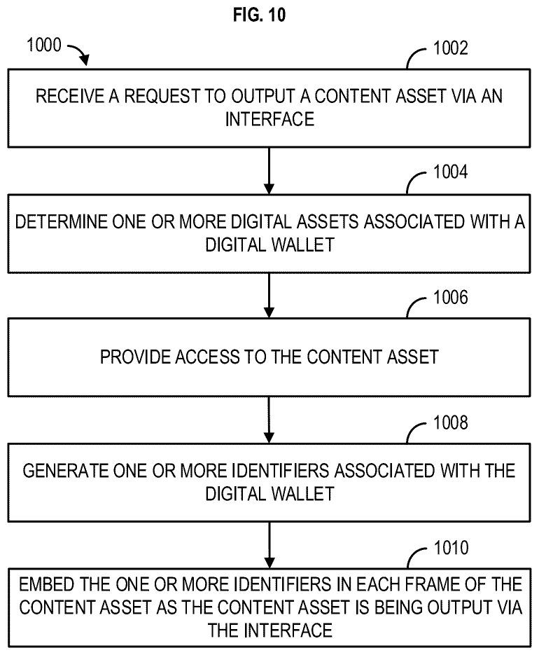

FIG. 10 shows a flowchart of an example method 1000 of providing access to a content asset based on whether a user owns one or more digital assets (e.g., digital wallet contains one or more digital assets). The method may be implemented by one or more user devices (e.g., server computing device 101, admin device 102, user devices 103, or any combination thereof) or can be encoded into a smart contract. At step 1002, a request to output a content asset via an interface may be received based on a digital wallet. For example, a device (e.g., server computing device 101, admin device 102, user devices 103, etc.) may receive the request to output the content asset via the interface based on the digital wallet. The content asset may comprise a plurality of frames. The interface may comprise a webpage or a user application. In an example, the interface may be formatted for virtual reality (VR) or augmented reality (AR).

At step 1004, one or more digital assets associated with the digital wallet may be determined. For example, the one or more digital assets associated with the digital wallet may be determined by the device (e.g., server computing device 101, admin device 102, user devices 103, etc.). The one or more digital assets may comprise one or more cryptocurrencies, one or more tokens, or one or more non-fungible tokens (NFTs).

At step 1006, access to the content asset may be provided based on a digital asset of the one or more digital assets. For example, the device (e.g., server computing device 101, admin device 102, user devices 103, etc.) may provide access to the content asset based on a digital asset of the one or more digital assets. In an example, the device may determine one or more required digital assets for gaining access to the content asset. For example, access to the content asset may be granted based on a user/owner of the digital wallet owning at least one of the required digital assets (e.g., the at least one required digital asset is included in the user's digital wallet). The device may provide access to the content asset based on the digital asset matching at least one required digital asset of the one or more required digital assets.

At step 1008, one or more identifiers associated with the digital wallet may be generated based on providing access to the content asset. For example, the device (e.g., server computing device 101, admin device 102, user devices 103, etc.) may generate the one or more identifiers associated with the digital wallet based on providing access to the content asset. The one or more identifiers may comprise one or more of a unique user identifier associated with an owner of the digital wallet, the digital asset, a wallet address of the digital wallet, a forensic watermark, a visible watermark, metadata, or software codes associated with the digital wallet.

At step 1010, the one or more identifiers may be embedded in each frame of the content asset as the content asset is being output via the interface. For example, the device (e.g., server computing device 101, admin device 102, user devices 103, etc.) may embed the one or more identifiers in each frame of the content asset as the content asset is being output via the interface. For example, an identifier may comprise an indication or image of the digital asset (e.g., NFT), an indication or image of the wallet address, or an indication or image of a combination of both the digital asset and the wallet address. The indication/image may be embedded, imperceptibly or visibly, into each frame of the content asset as the content asset is being output via the interface. The indication/image may be tracked each time the digital asset is output. For example, if a user attempts to share the content asset or the content asset is leaked without authorization, the identifier may be tracked as the content asset is output. Thus, the unauthorized access/sharing of the content asset may be traced back to the digital wallet (e.g., via the embedded NFT or the embedded wallet address) that shared/leaked the content asset without authorization.

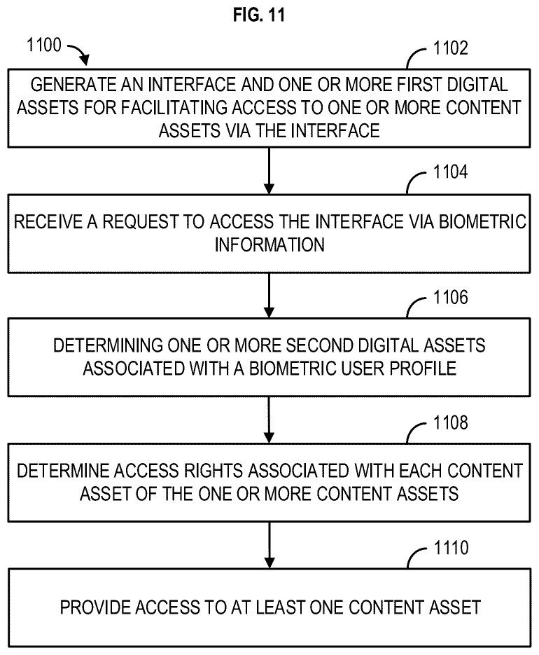

FIG. 11 shows a flowchart of an example method 1100 of providing access to a content asset based on whether a user owns one or more digital assets (e.g., a biometric user profile is associated with one or more digital assets). The method may be implemented by one or more devices (e.g., server computing device 101, admin device 102, user devices 103, any combination thereof, etc.) or can be encoded into a smart contract. At step 1102, an interface and one or more first digital assets for facilitating access to one or more content assets via the interface may be generated. For example, a device (e.g., server computing device 101, admin device 102, user devices 103, etc.) may generate the interface and the one or more first digital assets for facilitating access to the one or more content assets via the interface. The interface may comprise a webpage or a user application (e.g., installed on a user device). In an example, the interface may be formatted for virtual reality (VR) or augmented reality (AR). The one or more content assets may comprise one or more of image content, video content, or audio content. In an example, the one or more content assets may be stored on one or more of a server or a blockchain network. The one or more first digital assets may comprise one or more cryptocurrencies, one or more tokens, or one or more non-fungible tokens (NFTs).

At step 1104, a request to access the interface via biometric information may be received. For example, the request to access the interface via the digital wallet may be received by the device (e.g., server computing device 101, admin device 102, user devices 103, etc.). The biometric information may comprise one or more of physical biometric data associated with a user or behavioral biometric data associated with the user. The physical biometric data may comprise one or more of a fingerprint, palm veins, facial features, DNA, a palm print, hand geometrics, iris recognition, voice, or gait. The behavioral biometric data may comprise one or more of continuous authentication, keystrokes associated with a user device, location data, or lip movements. As an example, a biometric user profile for identifying a user associated with the request may be determined based on the biometric information. The biometric user profile may be associated with one or more second digital assets. In an example, the interface may authenticate the user associated with the biometric user profile, wherein the biometric user profile may be used to validate ownership (e.g., the user) of the one or more second digital assets. For example, the user's biometric information may be collected when the user purchases access to the content assets. A biometric user profile for the user may be generated based on the user's biometric information. The subscriptions to the content assets may be associated with the user's biometric user profile. As an example, instead of using a wallet address of a user's digital wallet for accessing the blockchain and confirming the ownership of the digital assets, the user's biometric information may be used to access the blockchain and confirm the digital assets associated with the user's biometric user profile (e.g., showing the user owns the digital assets). The user may be granted access to the content assets based on whether the user has the required digital assets associated with the user's biometric user profile. In an example, each second digital asset of the one or more second digital assets may comprise identifying information of an owner (e.g., the user) of the one or more second digital assets.

At step 1106, the one or more second digital assets associated with the biometric user profile may be determined. For example, the device (e.g., server computing device 101, admin device 102, user devices 103, etc.) may determine the one or more second digital assets associated with the biometric user profile. The one or more second digital assets may comprise one or more of one or more cryptocurrencies, one or more tokens, or one or more non-fungible tokens (NFTs).

At step 1108, access rights associated with each content asset of the one or more content assets may be determined based on the one or more second digital assets and the one or more first digital assets. For example, the device (e.g., server computing device 101, admin device 102, user devices 103, etc.) may determine the access rights associated with each content asset of the one or more content assets based on the one or more second digital assets and the one or more first digital assets. In an example, based on at least one second digital asset of the one or more second digital assets matching at least one first digital asset of the one or more first digital assets, the access rights may be determined to indicate the user associated with the biometric user profile has access to the at least one content asset. In an example, based on at least one second digital asset of the one or more second digital assets not matching at least one first digital asset of the one or more first digital assets, the access rights may be determined to indicate the user associated with the biometric user profile does not have access to the at least one content asset.

At step 1110, access may be provided to the at least one content asset based on the access rights associated with each content asset. For example, the device (e.g., server computing device 101, admin device 102, user devices 103, etc.) may provide access to the at least one content asset based on the access rights associated with each content asset. In an example, based on the access rights indicating the user associated with the biometric user profile does not have access to the at least one content asset, an option to purchase at least one of the one or more first digital assets may be provided to the user associated with the biometric user profile accessing the interface. Based on the user associated with the biometric user profile purchasing the at least one of the one or more first digital assets, the access rights may be updated to indicate that the user associated with the biometric user profile has access to the at least one content asset. In an example, the one or more content assets may be encrypted. A decryption key may be associated with the biometric user profile based on the access rights associated with each content asset. The decryption key may be used by the user associated with the biometric user profile to decrypt the at least one content asset and access the content asset.

In an example, one or more identifiers may be generated based on the access rights associated with each content asset. The one or more identifiers may comprise one or more of a unique user identifier associated with a user associated with the biometric user profile, a forensic watermark, or metadata. The one or more identifiers may be embedded in one or more of the interface (e.g., display of the interface) or the at least one content asset (e.g., digital rights management (DRM) protection). The interface and/or the at least one content asset embedded with the one or more identifiers may be unique for each user that accesses the content asset. For example, DRM may be used to prevent the unauthorized access to the content asset, such as preventing the sharing of a URL of the content asset to an unauthorized individual and preventing an unauthorized individual from recording the content asset.

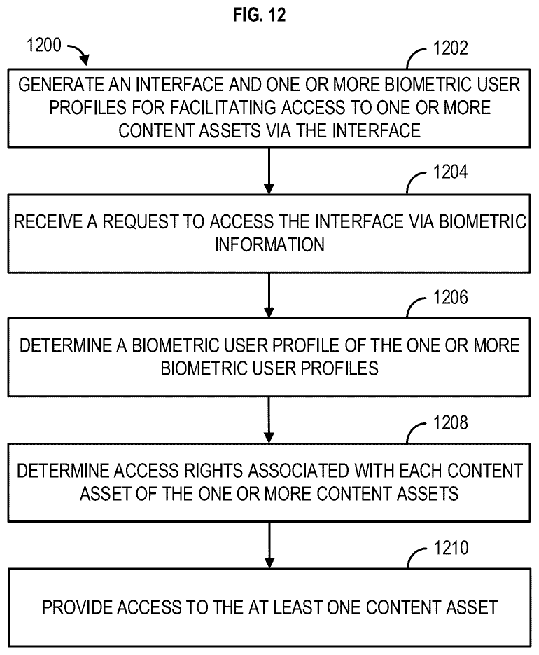

FIG. 12 shows a flowchart of an example method 1200 of providing access to a content asset based on whether a biometric user profile, associated with a user, is associated with access (e.g., via a subscription attached to the biometric user profile) to one or more content assets. The method may be implemented by one or more devices (e.g., server computing device 101, admin device 102, user devices 103, any combination thereof, etc.) or can be encoded into a smart contract. At step 1202, an interface and one or more biometric user profiles for facilitating access to one or more content assets via the interface may be generated. For example, a device (e.g., server computing device 101, admin device 102, user devices 103, etc.) may generate the interface and the one or more biometric user profiles for facilitating access to the one or more content assets via the interface. The interface may comprise a webpage or a user application (e.g., installed on a user device). In an example, the interface may be formatted for virtual reality (VR) or augmented reality (AR). The one or more content assets may comprise one or more of image content, video content, or audio content.

At step 1204, a request to access the one or more content assets via biometric information may be received. For example, the device (e.g., server computing device 101, admin device 102, user devices 103, etc.) may receive the request to access the one or more content assets via the biometric information. The biometric information may comprise one or more of physical biometric data associated with a user or behavioral biometric data associated with the user. The physical biometric data may comprise one or more of a fingerprint, palm veins, facial features, DNA, a palm print, hand geometrics, iris recognition, voice, or gait. The behavioral biometric data may comprise one or more of continuous authentication, keystrokes associated with a user device, location data, or lip movements.

At step 1206, a biometric user profile of the one or more biometric user profiles may be determined based on the biometric information. For example, the device (e.g., server computing device 101, admin device 102, user devices 103, etc.) may determine the biometric user profile of the one or more biometric user profiles based on the biometric information. In an example, the interface may authenticate the user associated with the biometric user profile. For example, the user's biometric information may be collected when the user purchases access to the content assets. A biometric user profile for the user may be generated based on the user's biometric information. The subscriptions to the content assets may be associated with the user's biometric user profile. The user may be granted access to the content assets based on whether the user's biometric user profile is associated with subscriptions to the content assets.

At step 1208, access rights associated with each content asset of the one or more content assets may be determined based on the biometric user profile. For example, the device (e.g., server computing device 101, admin device 102, user devices 103, etc.) may determine the access rights associated with each content asset of the one or more content assets based on the biometric user profile.

At step 1210, access may be provided to the at least one content asset based on the access rights associated with each content asset. For example, the device (e.g., server computing device 101, admin device 102, user devices 103, etc.) may provide access to the at least one content asset based on the access rights associated with each content asset. In an example, the one or more content assets may be encrypted. A decryption key may be associated with the biometric user profile of the digital wallet based on the access rights associated with each content asset. The decryption key may be used by the user associated with the biometric user profile to decrypt the at least one content asset and access the content asset.

In an example, one or more identifiers may be generated based on the access rights associated with each content asset. The one or more identifiers may comprise one or more of a unique user identifier associated with a user associated with the biometric user profile, a forensic watermark, or metadata. The one or more identifiers may be embedded in one or more of the interface (e.g., display of the interface) or the at least one content asset (e.g., digital rights management (DRM) protection). The interface and/or the at least one content asset embedded with the one or more identifiers may be unique for each user that accesses the content asset. For example, DRM may be used to prevent the unauthorized access to the content asset, such as preventing the sharing of a URL of the content asset to an unauthorized individual and preventing an unauthorized individual from recording the content asset.

Each of the constitutional elements described in the present document may consist of one or more components, and names thereof may vary depending on a type of an electronic device. The electronic device according to various exemplary embodiments may include at least one of the constitutional elements described in the present document. Some of the constitutional elements may be omitted, or additional other constitutional elements may be further included. Further, some of the constitutional elements of the electronic device according to various exemplary embodiments may be combined and constructed as one entity, so as to equally perform functions of corresponding constitutional elements before combination.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
generating, by a computing device, an interface and one or more first digital assets for facilitating access to one or more content assets via the interface;
receiving a request to access the interface via a digital wallet, wherein the digital wallet is associated with a wallet address;
determining one or more second digital assets associated with the digital wallet;
determining, based on the one or more second digital assets and the one or more first digital assets, access rights associated with each content asset of the one or more content assets;
generating, based on the access rights associated with each content asset, one or more identifiers associated with the wallet address for facilitating access to at least one content asset of the one or more content assets; and
providing, based on the one or more identifiers, access to the at least one content asset.

2. The method of claim 1, wherein the interface comprises a webpage or a user application.

3. The method of claim 1, wherein the one or more content assets comprise one or more of image content, video content, or audio content, wherein the one or more content assets are stored on one or more of a server or a blockchain network, and wherein one or more of the one or more first digital assets or the one or more second digital assets comprise one or more cryptocurrencies, one or more tokens, or one or more non-fungible tokens (NFTs).

4. The method of claim 1, wherein access is provided to the interface based on one or more of a QR code of the interface, a wallet extension associated with the digital wallet, a hard wallet associated with the digital wallet, physical biometric data associated with the digital wallet, or behavioral biometric data associated with the digital wallet, wherein the physical biometric data comprises one or more of a fingerprint, palm veins, facial features, DNA, a palm print, hand geometrics, iris recognition, voice, or gait, wherein the behavioral biometric data comprises one or more of continuous authentication, keystrokes associated with a user device, location data, or lip movements.

5. The method of claim 4, wherein a biometric user profile for identifying a user associated with the digital wallet is generated based on one or more of the physical biometric data or the behavioral biometric data.

6. The method of claim 1, wherein determining, based on the one or more second digital assets and the one or more first digital assets, the access rights associated with each content asset comprises determining, based on at least one second digital asset of the one or more second digital assets matches at least one first digital asset of the one or more first digital assets, the access rights indicate an owner of the digital wallet has access to the at least one content asset.

7. The method of claim 1, wherein determining, based on the one or more second digital assets and the one or more first digital assets, the access rights associated with each content asset comprises determining, based on at least one second digital asset of the one or more second digital assets does not match at least one first digital asset of the one or more first digital assets, the access rights indicate an owner of the digital wallet does not have access to the at least one content asset, and wherein the method further comprises:
providing an option to purchase at least one of the one or more first digital assets; and
updating, based on the owner of the digital wallet purchasing the at least one of the one or more first digital assets, the access rights to indicate the owner has access to the at least one content asset,
wherein generating, based on the access rights associated with each content asset, the one or more identifiers comprises generating, based on the updated access rights associated with each content asset, the one or more identifiers.

8. The method of claim 1, wherein the one or more identifiers comprise one or more of a unique user identifier associated with an owner of the digital wallet, at least one second digital asset of the one or more second digital assets, the wallet address, a forensic watermark, a visible watermark, metadata, or software codes associated with the digital wallet.

9. The method of claim 1, wherein the one or more content assets are encrypted, wherein providing, based on the one or more identifiers, access to the at least one content asset comprises:
associating, based on the one or more identifiers, a decryption key with the wallet address,
wherein the decryption key is used by an owner of the digital wallet to decrypt the at least one content asset and access the content asset.

10. The method of claim 1, further comprising embedding the one or more identifiers in one or more of the interface or the at least one content asset.

11. A method comprising:
generating, by a computing device, an interface and one or more first digital assets for facilitating access to one or more content assets via the interface;
receiving a request to access the interface via a digital wallet, wherein the digital wallet is associated with a wallet address;
determining one or more second digital assets associated with the digital wallet;
determining, based on the one or more second digital assets and the one or more first digital assets, access rights associated with each content asset of the one or more content assets;
providing, based on the access rights associated with each content asset, access to at least one content asset of the one or more content assets; and
associating, based on providing access to the at least one content asset, one or more identifiers with one or more of the interface or the at least one content asset, wherein the one or more identifiers are associated with the wallet address.

12. The method of claim 11, wherein the interface comprises a webpage or a user application.

13. The method of claim 11, wherein the one or more content assets comprise one or more of image content, video content, or audio content, wherein the one or more content assets are stored on one or more of a server or a blockchain network, and wherein one or more of the one or more first digital assets or the one or more second digital assets comprise one or more cryptocurrencies, one or more tokens, or one or more non-fungible tokens (NFTs).

14. The method of claim 11, wherein access is provided to the interface based on one or more of a QR code of the interface, a wallet extension associated with the digital wallet, a hard wallet associated with the digital wallet, physical biometric data associated with the digital wallet, or behavioral biometric data associated with the digital wallet, wherein the physical biometric data comprises one or more of a fingerprint, palm veins, facial features, DNA, a palm print, hand geometric, iris recognition, voice, or gait, wherein the behavioral biometric data comprises one or more of continuous authentication, keystrokes associated with a user device, location data, or lip movements.

15. The method of claim 14, wherein a biometric user profile for identifying a user associated with the digital wallet is generated based on one or more of the physical biometric data or the behavioral biometric data.

16. The method of claim 11, wherein determining, based on the one or more second digital assets and the one or more first digital assets, the access rights associated with each content asset comprises determining, based on at least one second digital asset of the one or more second digital assets matches at least one first digital asset of the one or more first digital assets, the access rights indicate an owner of the digital wallet has access to the at least one content asset.

17. The method of claim 11, wherein determining, based on the one or more second digital assets and the one or more first digital assets, the access rights associated with each content asset comprises determining, based on at least one second digital asset of the one or more second digital assets does not match at least one first digital asset of the one or more first digital assets, the access rights indicate an owner of the digital wallet does not have access to the at least one content asset, and wherein the method further comprises:
providing an option to purchase at least one of the one or more first digital assets; and
updating, based on the owner of the digital wallet purchasing the at least one of the one or more first digital assets, the access rights to indicate the owner has access to the at least one content asset,
wherein providing, based on the access rights associated with each content asset, access to the at least one content asset of the one or more content assets comprises providing, based on the updated access rights associated with each content asset, access to the at least one content asset of the one or more content assets.

18. The method of claim 11, wherein the one or more identifiers comprise one or more of a unique user identifier associated with an owner of the digital wallet, at least one second digital asset of the one or more second digital assets, the wallet address, a forensic watermark, a visible watermark, metadata, or software codes associated with the digital wallet.

19. The method of claim 11, wherein the one or more content assets are encrypted, wherein providing, based on the access rights associated with each content asset, access to the at least one content asset comprises:
associating, based on the access rights associated with each content asset, a decryption key with the wallet address,
wherein the decryption key is used by an owner of the digital wallet to decrypt the at least one content asset and access the content asset.

20. The method of claim 11, wherein associating the one or more identifiers with one or more of the interface or the at least one content asset comprises embedding the one or more identifiers in one or more of the interface or the at least one content asset.

21. A method comprising:
receiving, by a computing device, based on a digital wallet, a request to output a content asset via an interface, wherein the content asset comprises a plurality of frames;
determining one or more digital assets associated with the digital wallet;
providing, based on a digital asset of the one or more digital assets, access to the content asset, wherein the content asset is output via the interface based on being provided access to the content asset;
generating, based on providing access to the content asset, one or more identifiers associated with the digital wallet; and
embedding the one or more identifiers in each frame of the content asset as the content asset is being output via the interface.

22. The method of claim 21, wherein the interface comprises a webpage or a user application.

23. The method of claim 21, wherein the one or more digital assets comprise one or more cryptocurrencies, one or more tokens, or one or more non-fungible tokens (NFTs).

24. The method of claim 21, wherein providing, based on the digital asset of the one or more digital assets, access to the content asset comprises:
determining one or more required digital assets for gaining access to the content asset; and
providing, based on the digital asset matching at least one required digital asset of the one or more required digital assets, access to the content asset.

25. The method of claim 21, wherein the one or more identifiers comprise one or more of a unique user identifier associated with an owner of the digital wallet, the digital asset, a wallet address of the digital wallet, a forensic watermark, a visible watermark, metadata, or software codes associated with the digital wallet.

26. The method of claim 21, embedding the one or more identifiers in each frame of the content asset as the content asset is being output via the interface comprising imperceptibly embedding the one or more identifiers in each frame of the content asset as the content asset is being output via the interface.

27. The method of claim 21, further comprising tracking, based on output of the content asset, the one or more identifiers.
